(19) United States
(12) Patent Application Publication
(10) Pub. No.: US 2026/0086542 A1
(43) Pub. Date: Mar. 26, 2026

(54) MONITORING PERFORMANCE OF CONTROLLERS

(71) Applicant: Honeywell International Inc., Charlotte, NC (US)

(72) Inventors: Venkata Rao Venkamsetty, Bangalore (IN); Maninder Singh Sidhu, Nanded, IN (US); Mukund Joshi, Pune (IN); Vikram Singh Vaish, Bangalore (IN); Rahul AV, Bangalore (IN); Harikrishnan Ravindranathan, Ernakulam (IN)

(21) Appl. No.: 18/892,615

(22) Filed: Sep. 23, 2024

(51) Int. Cl. G05B 19/418

(52) U.S. Cl. CPC G05B 19/41875; G05B 2219/32366

(57) ABSTRACT

Techniques for monitoring performance of controllers are disclosed. A system for monitoring performance of controllers comprising a processing unit. A set of key performance indicators (KPIs) corresponding to a controller are obtained. The controller may be configured to control a compressor. A user-defined analysis model is configured based on a set of user inputs. A control quality index (CQI) is determined based on a plurality of KPIs from the set of KPIs using the user-defined analysis model. The CQI defines performance of the controller in terms of utilization, availability, and reliability of the controller. The CQI is compared with a threshold value. A notification indicating that the CQI is less than the threshold value is triggered and an action indicating corrective measures to be taken to improve performance of the controller is generated based on an ascertaining that the CQI is lesser than the threshold value.

### BACKGROUND

Generally, industrial plants, such as manufacturing, automotive, chemicals, refinery, power plants, and the like, deploy driving components, including compressor, turbines, and so on, for various purposes. As an example, industrial plants include driving components for purposes, such as operation of air tools, air pumps, spraying tools, air-conditioners, pneumatic valves and actuators, and the like. For instance, in a power plant, air compressors may be used to supply compressed air for operating pneumatic valves that are used to turn on or turn off diesel engines. In another scenario, multiple air compressors may also be used in the power plants to drive the actuators that are to start and stop the diesel engines.

Conventionally, in industrial plants, each of the driving components may be controlled by one or more controllers. For instance, a compressor to drive a pump may be controlled by one or more controllers. Similarly, a compressor to operate pneumatic valves may be controlled by one or more controllers, and so on. Particularly, the compressors are controlled by a performance controller, an anti-surge controller, and a speed controller. Accordingly, in industrial plants, there are numerous controllers configured to control various compressors.

### SUMMARY

In the present subject matter, a system for monitoring performance of controllers may include a processing unit. The processing unit may obtain a set of key performance indicators (KPIs) corresponding to a controller. The set of KPIs being indicative of performance of the controller. The controller may be configured to control a compressor. In an example, the controller may be a performance controller. In another example, the controller may be an anti-surge controller. The processing unit may configure a user-defined analysis model based on a set of user inputs. The processing unit may determine a control quality index (CQI) based on a plurality of KPIs from the set of KPIs using the user-defined analysis model. The CQI may define performance of the controller in terms of utilization of the controller, availability of the controller, and reliability of the controller. The processing unit may compare the CQI with a threshold value in response to the determination of the CQI and ascertain if the CQI is lesser than the threshold value based on the comparison. Furthermore, the processing unit may trigger a notification indicating that the CQI is less than the threshold value and generate an action indicating corrective measures to be taken to improve performance of the controller based on the ascertaining that the CQI is lesser than the threshold value.

In an example, the processing unit may select, based on the user-defined analysis model, the plurality of key performance indicators from the set of key performance indicators in response to the configuration of the user-defined analysis model.

The KPIs may, for example, comprise an effective service factor of the controller, a standard deviation of the controller, and an output deviation of the controller. In this regard, using the user-defined analysis mode, the processing unit may compare the effective service factor of the controller with an effective service factor threshold, the standard deviation of the controller with a standard deviation threshold, and the output deviation of the controller with an output deviation threshold. The processing unit may determine the CQI based on the comparison the effective service factor of the controller and the effective service factor threshold, the standard deviation of the controller and the standard deviation threshold, and the output deviation of the controller and the output deviation threshold.

In an example, using the user-defined analysis model, the processing unit may determine the CQI as a first value if the effective service factor of the controller is at least one of: lesser than and equal to the effective service factor threshold, if the standard deviation of the controller is at least one of: equal to and greater than the standard deviation threshold, and the output deviation of the controller is at least one of: equal to and greater than the output deviation threshold. Using the user-defined analysis model, the processing unit may determine the CQI as a second value if the effective service factor of the controller is greater than the effective service factor threshold, if the standard deviation of the controller is at least one of: equal to and greater than the standard deviation threshold, and the output deviation of the controller is at least one of: equal to and greater than the output deviation threshold. Using the user-defined analysis model, the processing unit may determine the CQI as a third value if the effective service factor of the controller is greater than the effective service factor threshold, if the standard deviation of the controller is less than the standard deviation threshold, and the output deviation of the controller is less than the output deviation threshold. The third value may be the CQI threshold value.

The set of user inputs may comprise a time period for the determination of the CQI. The processing unit may define, based on the user-defined analysis model, a time period for the determination of the CQI. The processing unit may determine, using the user-defined analysis model, the CQI for the defined time period. The processing unit may display, on a device, at least one of: the CQI, the notification, and the generated action.

In an example, a method for monitoring performance of controllers may include obtaining, from a first controller, a first set of KPIs corresponding to the first controller. The first set of the KPIs may be indicative of performance of the first controller. A second set of KPIs corresponding to a second controller may be obtained from the second controller. The second set of the KPIs may be indicative of performance of the second controller. The first controller and the second controller may be configured to control a compressor. A first user-defined analysis model may be configured based on a first set of user inputs and a second user-defined analysis model may be configured based on a second set of user inputs. A first control quality index (CQI) may be determined based on a first plurality of KPIs from the first set of KPIs using the first user-defined analysis model. The first CQI may define performance of the first controller in terms of utilization of the controller, availability of the controller, and reliability of the controller. A second CQI may be determined based on a second plurality of KPIs from the second set of KPIs using a second user-defined analysis model. The second CQI may define performance of the second controller in terms of utilization of the controller, availability of the controller, and reliability of the controller. The first CQI may be compared with a first threshold value in response to the determination of the first CQI. The second CQI may be compared with a second threshold value in response to the determination of the second CQI. A first notification indicating that the first CQI is lesser than the first threshold value may be triggered and a first action indicating corrective measures to be taken to improve performance of the first controller may be generated if it is ascertained that the first CQI is lesser than the first threshold value. Similarly, a second notification indicating that the second CQI is lesser than the second threshold value may be triggered and a second action indicating corrective measures to be taken to improve performance of the second controller may be generated if it is ascertained that the second CQI is lesser than the second threshold value.

The method may include selecting, based on the first user-defined analysis model, the first plurality of KPIs from the first set of KPIs. Similarly, the method may include selecting, based on the second user-defined analysis model, the second plurality of KPIs from the second set of KPIs.

In an example, the first controller may be one of: a performance controller and an anti-surge controller and the second controller may be the other of: the performance controller and the anti-surge controller. When the first controller is a performance controller, the first plurality of KPIs may include an effective service factor of the first controller, a standard deviation of the first controller, and an output deviation of the first controller. In this regard, the method may include comparing, using the first user-defined analysis model, the effective service factor of the first controller with an effective service factor threshold, the standard deviation of the first controller with a standard deviation threshold, and the output deviation of the first controller with an output deviation threshold. Further, the method may include determining the first CQI based on the comparison the effective service factor of the first controller and the effective service factor threshold, the standard deviation of the first controller and the standard deviation threshold, and the output deviation of the first controller and the output deviation threshold.

In another example, when the second controller is an anti-surge controller, the second plurality of KPIs may include an effective service factor of the second controller, an effectiveness of the second controller, and an output deviation of the second controller. The method may include comparing, using the second user-defined analysis model, the effective service factor of the second controller with an effective service factor threshold, the effectiveness of the second controller with an effectiveness threshold, and the output deviation of the second controller with an output deviation threshold. The method may further include determining the second CQI based on the comparison the effective service factor of the second controller and the effective service factor threshold, the effectiveness of the second controller and the effectiveness threshold, and the output deviation of the second controller and the output deviation threshold.

The determination of the CQI may be performed as follows. The second CQI may be determined, by using the second user-defined analysis model, as a first value if the effective service factor of the second controller is at least one of: lesser than and equal to the effective service factor threshold, if the effectiveness of the second controller is at least one of: equal to and greater than the effectiveness threshold, and the output deviation of the second controller is at least one of: equal to and greater than the output deviation threshold. Similarly, the second CQI may be determined, by using the second user-defined analysis model, as a second value if the effective service factor of the second controller is greater than the effective service factor threshold, if the effectiveness of the second controller is at least one of: equal to and greater than the effectiveness threshold, and the output deviation of the second controller is at least one of: equal to and greater than the output deviation threshold. Yet further, the second CQI may be determined, by using the second user-defined analysis model, as a third value if the effective service factor of the second controller is greater than the effective service factor threshold, if the effectiveness of the second controller is less than the effectiveness threshold, and the output deviation of the second controller is less than the output deviation threshold. The third value may be the second threshold value again which the determined CQI value may be compared with as explained above

In an example, obtaining the first set of KPIs from the first controller may include establishing connection, by using the transfer service, with the first controller. Further, the transfer service may subscribe to tags of data corresponding to the first set of KPIs using Open Platform Communication (OPC) protocol. The first set of KPIS may be pulled by the transfer service in response to determining a change in data corresponding to the first set of KPIs. Further, the method may include transmitting, by the transfer service, the first set of key performance indicators in Comma Separated Value (CSV) format using Secure File Transfer Protocol (SFTP).

In an example, a non-transitory computer-readable medium may comprise instructions for monitoring performance of controllers. The instructions may be executable by a processing resource to obtain, from a performance controller, a first set of KPIs corresponding to the performance controller. The performance controller may be configured to control a compressor. The first set of the KPIs may be indicative of performance of the performance controller. The instructions may be executable to configure a first user-defined analysis model based on a first set of user inputs and to select, based on the first user-defined analysis model, a first plurality of key performance indicators from the first set of key performance indicators. Further, the instructions may be executable to determine a first CQI based on the first plurality of KPIs selected from the first set of KPIs using the first user-defined analysis model. The first CQI may define performance of the performance controller in terms of utilization of the performance controller, availability of the performance controller, and reliability of the performance controller. The instructions may be executable to compare the first CQI with a threshold value upon the determination of the first CQI. In addition, the instructions may be executable to ascertain if the first CQI is lesser than the threshold value based on the comparison and trigger a first notification indicating that the first CQI is less than the threshold value. Further, the instructions may be executable to generate a first action indicating corrective measures to be taken to improve performance of the performance controller based on the ascertaining that the first CQI is lesser than the threshold value. In addition, the instructions may be executable to refrain from triggering the first notification and from generating the first action indicating the corrective measures based on the ascertaining that the first CQI is greater than the threshold value.

In an example, wherein the first set of user inputs may include a time period for the determination of the first CQI. In this regard, the instructions may be to define, based on the first user-defined analysis model, a time period for the determination of the first CQI and to determine, using the first user-defined analysis model, the first CQI for the defined period duration.

The instructions may be executable by the processing resource to obtain, from an anti-surge controller, a second set of KPIs corresponding to the anti-surge controller corresponding to a compressor. The second set of the KPIs being indicative of performance of the anti-surge controller. The instructions may be to configure a second user-defined analysis model based on a second set of user inputs and select, based on the second user-defined analysis model, a second plurality of key performance indicators from the second set of key performance indicators. Further, the instructions may include determining a second CQI based on the second plurality of KPIs selected from the second set of KPIs using the second user-defined analysis model. The second CQI may define performance of the anti-surge controller in terms of utilization of the anti-surge controller, availability of the anti-surge controller, and reliability of the anti-surge controller. The instructions may be executable by the processing resource to compare the second CQI with a threshold value in response to the determination of the second CQI and ascertain if the second CQI is lesser than the threshold value based on the comparison. The instructions may be executable by the processing resource to trigger a second notification indicating that the second CQI is less than the threshold value and generate a second action indicating corrective measures to be taken to improve performance of the anti-surge controller based on the ascertaining that the second CQI is lesser than the threshold value. Further, the instructions may be executable by the processing resource to refrain from triggering the second notification and generating the second action indicating the corrective measures based on the ascertaining that the second CQI is greater than the threshold value.

In an example, the second set of user inputs include a time period for the determination of the second CQI. In this regard, the instructions may be executable by the processing resource to define, based on the second user-defined analysis model, the time period for the determination of the second CQI and determine, using the second user-defined analysis model, the second CQI for the time period.

### BRIEF DESCRIPTION OF DRAWINGS

The detailed description is provided with reference to the accompanying figures. In the figures, the left-most digit(s) of a reference number identifies the figure in which the reference number first appears. The same numbers are used throughout the drawings to reference like features and components.

FIG. 1 illustrates a system for monitoring performance of controllers, according to an example implementation of the present subject matter.

FIG. 2 illustrates a system for monitoring performance of controllers, according to an example implementation of the present subject matter.

FIG. 3 illustrates a network architecture corresponding to monitoring performance of controllers, according to an example implementation of the present subject matter.

FIG. 4a illustrates components in a second level of a network architecture corresponding to monitoring performance of controllers, according to an example implementation of the present subject matter.

FIG. 4b illustrates components in a fourth level of a network architecture corresponding to monitoring performance of controllers, according to an example implementation of the present subject matter.

FIG. 5 illustrates a system for monitoring performance of controllers, according to an example implementation of the present subject matter.

FIGS. 6a-6d illustrate a method for monitoring performance of controllers, according to an example implementation of the present subject matter.

FIGS. 7a-7b illustrate a method for monitoring performance of controllers, according to an example implementation of the present subject matter and

FIGS. 8a-8b illustrate a computing environment, implementing a non-transitory computer-readable medium for monitoring performance of controllers, according to an example implementation of the present subject matter.

### DETAILED DESCRIPTION

Typically, in industrial plants, one or more controllers may be used to control one or more driving components, such as compressors, and the like. Specifically, a compressor may be controlled by controllers, such as a performance controller, an anti-surge controller, and a speed controller. The performance controller may regulate, for example, throughput of the compressors. Particularly, the performance controller regulates pressure measurements, compression ratio, pressure compensated mass flow, temperature compensated mass flow, and the like, integrate with other controllers corresponding to the compressors, and the like. The anti-surge controller may enable protection of the compressor from choking (surging). The anti-surge controller may maintain the compressor operating point to prevent the compressor operating point from reaching a surge limit. The anti-surge controllers may regulate components, including a blow-off vent, a control valve, to maintain the compressor operating point without reaching the surge limit. The surge limit may be a relative function and may be dependents on design of vanes, composition of fluid flowing through the compressor, pressure of the fluid, temperature of the fluid, and so on. The speed controller may adjust capacity of the compressor by varying the speed of an electric motor driving the compressor.

The performance of the controllers may have to be monitored to prevent any malfunctioning of the controllers and thereby, to prevent the malfunctioning of the driving components. For instance, if the anti-surge controller does not modulate the blow-off valve before the compressor operating point reaching the surge limit, then the compressor may surge. Accordingly, the anti-surge controller may have to be monitored.

The monitoring of the controllers may be an arduous task. Generally, in an industrial plant, a person, such as a maintenance engineer, may monitor the performance and operation of the controllers. However, given the number of controllers associated with each compressor and given the number of compressors associated with various components in an industrial plant, the monitoring of the controllers at such a scale may be difficult, time-consuming, labour-intensive, and inefficient.

Conventionally, for the monitoring of the controllers, the maintenance engineer may have to check multiple parameters, such as key performance indicators (KPIs) of each controller. For instance, the KPIs corresponding to an anti-surge controller may include duration since maintenance, control of pressure, overall standard deviation of the controller from a set point value to the output value, overall control quality, overall service factor, and the like. As mentioned earlier, typically, in an industrial plant, there may be numerous controllers (for examples, to the tune of thousands) with each controller having numerous KPIs (for example, to the tune of hundreds) to be monitored. Therefore, the monitoring of the performance of the controllers using numerous KPIs may be a challenging task. For instance, if one or more of the KPIs are not within acceptable limits, then it may be deemed that there is an issue with the operation of the controller and timely action may have to be taken to address the issue. Assume that the anti-surge controller does not modulate the blow-off valve before the compressor operating point reaches the surge limit. In this regard, to identify the cause of the surging of the compressor, the maintenance engineer may have to look through multiple KPIs corresponding to the anti-surge controller. Further, the required corrective actions may have to be interpreted from numerous KPIs to address the issues. Accordingly, the monitoring of the controllers conventionally is a challenging task, results in a delay or downtime of components, and depends on manual expertise. Therefore, conventional techniques lack providing an overall assessment of performance of controllers. The lack of such assessment makes it difficult to attend to controllers that require corrective measures.

The present subject matter relates to monitoring performance of controllers. The present subject matter provides an overall assessment of a controller's performance is provided in terms of availability, reliability, and utilization. The provision of overall assessment enables monitoring performance of multiple controllers easily and simultaneously. Therefore, with the present subject matter, the controllers that require corrective measures can be attended to without any time delay irrespective of scale of the controllers.

In an example, the present subject matter may relate to techniques for monitoring performance of controllers. The controllers may correspond to the controllers configured to control compressors. The controllers will be explained with reference to controlling a single compressor. As an example, the controller may include a first controller and a second controller. The first controller may, for example, correspond to a performance controller and the second controller may, for example, correspond to an anti-surge controller. Hereinafter, the first controller will be explained with reference to the performance controller and the second controller will be explained with reference to an anti-surge controller.

The performance controller may regulate, for example, throughput of the compressor, such as regulating pressure measurements, compression ratio, pressure compensated mass flow, temperature compensated mass flow, and the like. Further, the performance controller may integrate with other controllers corresponding to the compressor. The anti-surge controller may enable protection of the compressor from choking (surging) and may maintain the compressor operating point to prevent the compressor operating point from reaching a surge limit. In this regard, the anti-surge controllers may regulate components, including a blow-off vent, control valves, to maintain the compressor operating point without reaching the surge limit. The performance monitoring of the performance controller will be explained below.

In an example, the techniques may include obtaining a first set of key performance indicators (KPIs). The first set of KPIs may be indicative of performance of the performance controller. The first set of KPIs may, for example, include an effective service factor of the performance controller, a standard deviation of the performance controller, a deviation of the performance controller, duration since maintenance, main control set point of the performance controller, control process variable of the performance controller, and the like.

In an example, for obtaining the first set of KPIs, a transfer service may connect to the performance controller. Further, the transfer service may be subscribed to data tags corresponding to the first set of KPIs using Open Platform Communication (OPC) protocol. The first set of KPIs may be pulled by the transfer service in response to determining a change in data corresponding to the first set of KPIs. The transfer service may transmit the first set of KPIs in Comma Separated Value (CSV) format using Secure File Transfer Protocol (SFTP).

A first user-defined analysis model may be configured based on a first set of user inputs. The first user-defined analysis model may, for example, enable selection of particular KPIs from the first set of KPIs and for determining a singular metric corresponding to the performance of the performance controller. In an example, the first set of user inputs may include selection of default KPIs from the first set of KPIs and default setting for threshold limits, as will be explained as follows. In another example, the first set of user inputs may include selection of KPIs by a user and setting of threshold limits by the user instead of selecting default settings.

Upon the configuration of the first user-defined analysis model, a first plurality of KPIs may be selected from among the first set of KPIs, as mentioned above. The first plurality of KPIs may be, for example, the effective service factor of the performance controller, the standard deviation of the performance controller, the deviation of the performance controller. The singular metric, a first Control Quality Index (CQI), may be determined based on the first plurality of KPIs. The first CQI may define performance of the performance controller in terms of utilization of the performance controller, availability of the performance controller, and reliability of the performance controller.

The first CQI may be determined using the first user-defined analysis model. In an example, for the determination of the first CQI, the effective service factor of the controller may be compared with an effective service factor threshold, the standard deviation of the controller may be compared with a standard deviation threshold, and the output deviation of the controller may be compared with an output deviation threshold using the user-defined analysis model. For instance, using the first user-defined analysis model, the first CQI may be determined as a first value if the effective service factor of the controller is at least one of: lesser than and equal to the effective service factor threshold, if the standard deviation of the controller is at least one of: equal to and greater than the standard deviation threshold, and the output deviation of the controller is at least one of: equal to and greater than the output deviation threshold. The first value may be, for example, 1 and may indicate ‘poor’ status of the first CQI. Similarly, the first CQI may be determined as a second value if the effective service factor of the controller is greater than the effective service factor threshold, if the standard deviation of the controller is at least one of: equal to and greater than the standard deviation threshold, and the output deviation of the controller is at least one of: equal to and greater than the output deviation threshold. The second value may be, for example, 2 and may indicate ‘bad’ status of the first CQI. Further, the first CQI may be determined as a third value if the effective service factor of the controller is greater than the effective service factor threshold, if the standard deviation of the controller is less than the standard deviation threshold, and the output deviation of the controller is less than the output deviation threshold. The third value may be, for example, ‘3’ and may indicate ‘Good’ status of the first CQI.

Subsequent to the determination of the first CQI, the first CQI may be compared with a threshold value and may ascertain if the first CQI is lesser than the threshold value. In an example, the threshold value may be, for example, the third value, i.e., 3. For instance, assume that the first CQI is 2. Based on the comparison, it may be ascertained that the first CQI is lesser than the threshold value. In this regard, if, based on the comparison, it is ascertained that the first CQI is lesser than the threshold value, a notification may be triggered and an action may be recommended. The notification may indicate that the first CQI is less than the threshold value. Further, the action may indicate corrective measures to be taken to improve performance of the controller. The first CQI, the notification, and the generated action may be displayed on a device, such as a display unit. In another example, if it is ascertained that the first CQI is lesser than the threshold value, the notification may not be triggered and the action indicating the corrective measures may not be generated.

In an example, the first set of user inputs may include a time period for the determination of the first CQI. In this regard, a time period for the determination of the first CQI may be defined based on the first user-defined analysis model and the first CQI may be determined for the defined time period using the first user-defined analysis model.

In the above examples, the singular metric corresponding to the performance controller is determined. In another example, the singular metric corresponding to the anti-surge controller may be determined, as will be explained below.

In an example, the techniques may include obtaining a second set of key performance indicators (KPIs). The second set of KPIs may be indicative of performance of the anti-surge controller. The second set of KPIs may, for example, include an effective service factor of the anti-surge controller, an effectiveness of the anti-surge controller, a deviation of the anti-surge controller, duration since maintenance, main control set point of the anti-surge controller, control process variable of the anti-surge controller, and the like.

For obtaining the second set of KPIs, a transfer service may connect to the anti-surge controller. Further, the transfer service may be subscribed to data tags corresponding to the second set of KPIs using Open Platform Communication (OPC) protocol. The second set of KPIs may be pulled by the transfer service in response to determining a change in data corresponding to the second set of KPIs. The transfer service may transmit the second set of KPIs in CSV format using SFTP.

A second user-defined analysis model may be configured based on a second set of user inputs. The second user-defined analysis model may, for example, enable selection of particular KPIs from the second set of KPIs and for determining a singular metric corresponding to the performance of the anti-surge controller. In an example, the second set of user inputs may include selection of default KPIs from the second set of KPIs and default setting for threshold limits, as will be explained as follows. In another example, the second set of user inputs may include selection of KPIs by a user and setting of threshold limits by the user instead of selecting default settings.

Upon the configuration of the second user-defined analysis model, a second plurality of KPIs may be selected from among the second set of KPIs, as mentioned above. The second plurality of KPIs may be, for example, the effective service factor of the anti-surge controller, the effectiveness of the anti-surge controller, the deviation of the anti-surge controller. The singular metric, a second Control Quality Index (CQI), may be determined based on the second plurality of KPIs. The second CQI may define performance of the anti-surge controller in terms of utilization of the anti-surge controller, availability of the anti-surge controller, and reliability of the anti-surge controller.

The second CQI may be determined using the second user-defined analysis model. In an example, for the determination of the second CQI, the effective service factor of the controller may be compared with an effective service factor threshold, the effectiveness of the controller may be compared with a effectiveness threshold, and the output deviation of the controller may be compared with an output deviation threshold using the user-defined analysis model. For instance, using the second user-defined analysis model, the second CQI may be determined as a second value if the effective service factor of the controller is at least one of: lesser than and equal to the effective service factor threshold, if the effectiveness of the controller is at least one of: equal to and greater than the effectiveness threshold, and the output deviation of the controller is at least one of: equal to and greater than the output deviation threshold. The second value may be, for example, 1 and may indicate ‘poor’ status of the second CQI. Similarly, the second CQI may be determined as a second value if the effective service factor of the controller is greater than the effective service factor threshold, if the effectiveness of the controller is at least one of: equal to and greater than the effectiveness threshold, and the output deviation of the controller is at least one of: equal to and greater than the output deviation threshold. The second value may be, for example, 2 and may indicate ‘bad’ status of the second CQI. Further, the second CQI may be determined as a third value if the effective service factor of the controller is greater than the effective service factor threshold, if the effectiveness of the controller is less than the effectiveness threshold, and the output deviation of the controller is less than the output deviation threshold. The third value may be, for example, ‘3’ and may indicate ‘Good’ status of the second CQI.

Subsequent to the determination of the second CQI, the second CQI may be compared with a threshold value and may ascertain if the second CQI is lesser than the threshold value. In an example, the threshold value may be, for example, the third value, i.e., 3. For instance, assume that the second CQI is 2. Based on the comparison, it may be ascertained that the second CQI is lesser than the threshold value. In this regard, if, based on the comparison, it is ascertained that the second CQI is lesser than the threshold value, a notification may be triggered and an action may be recommended. The notification may indicate that the second CQI is less than the threshold value. Further, the action may indicate corrective measures to be taken to improve performance of the controller. The second CQI, the notification, and the generated action may be displayed on a device, such as a display unit. In another example, if it is ascertained that the second CQI is lesser than the threshold value, the notification may not be triggered and the action indicating the corrective measures may not be generated.

In an example, the second set of user inputs may include a time period for the determination of the second CQI. In this regard, a time period for the determination of the second CQI may be defined based on the second user-defined analysis model and the second CQI may be determined for the defined time period using the second user-defined analysis model.

The present subject matter facilitates monitoring performance of controllers. The present subject matter provides an overall assessment of a controller's performance is provided in terms of availability, reliability, and utilization that is easy-to-understand. The provision of overall assessment enables monitoring performance of multiple controllers easily and simultaneously. Therefore, with the present subject matter, the controllers that require corrective measures can be attended to without any time delay irrespective of scale of the controllers. By eliminating the need to analyze multiple KPIs for each controller, the present subject matter significantly reduces time and effort required for performance monitoring of controllers. The present subject matter enables determination of CQI on-the-fly for user-defined time durations. This enables providing insights into controller performance over a period of time. The system can automatically notify users if the CQI reaches ‘bad’ status or ‘poor’ status. Thus, the present subject matter eliminates constant manual monitoring required by the users. Further, with the present subject matter, the singular metric can be determined based on default setting or can be determined based on settings provided by the user. Accordingly, the present subject matter enables flexibility in the determination of the overall assessment of the performance of the controllers. In the present subject matter, the data from the performance controller and the anti-surge controller are obtained in OPC architecture in the form of CSV using SFTP. Accordingly, the present subject matter can handle high frequency of data, in terms of milliseconds.

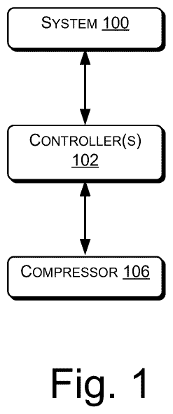

The present subject matter is further described with reference to FIGS. 1-8b. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a system 100 for monitoring performance of controllers 102, according to an example implementation of the present subject matter. The controllers 102 may correspond to the controllers that are configured to control a compressor 106. The compressor 106 may, for example, provide compressed fluid for various applications, such as operation of air tools, pumps, spraying tools, air-conditioners, pneumatic valves and actuators, and the like. The compressor 106 may be controlled by a plurality of controllers, such as a performance controller, an anti-surge controller, a speed controller, and the like.

The performance controller may regulate, for example, throughput of the compressors. Particularly, the performance controller regulates pressure measurements, compression ratio, pressure compensated mass flow, temperature compensated mass flow, and the like, integrate with other controllers corresponding to the compressors, and the like. The anti-surge controller may enable protection of the compressor from choking (surging). The anti-surge controller may maintain the compressor operating point to prevent the compressor operating point from reaching a surge limit. The anti-surge controllers may regulate components, including a blow-off vent, a control valve, to maintain the compressor operating point without reaching the surge limit. The surge limit may be a relative function and may be dependents on design of vanes, composition of fluid flowing through the compressor, pressure of the fluid, temperature of the fluid, and so on. The speed controller may adjust capacity of the compressor by varying the speed of an electric motor driving the compressor. Hereinafter, the controllers 102 will be explained with reference to a single controller.

The system 100 may monitor the performance of the controller 102. The system 100 may be and/or may include a microprocessor, a microcomputer, a microcontroller, a digital signal processor, a central processing unit, a state machine, a logic circuitry, or a device that manipulates signals based on operational instructions. Among other capabilities, the system 100 may fetch and execute computer-readable instructions stored in a memory, such as a volatile memory or a non-volatile memory, of the system 100. The system 100 may include a device (not shown in FIG. 1), such as a display device, for displaying parameters corresponding to monitoring performance of the controllers 102. The monitoring of performance of the controller 102 by the system 100 is explained below.

During operation, the system 100 may obtain a set of Key Performance Indicators (KPIs) corresponding to the controller 102. The controller 102 may be, for example, a performance controller or an anti-surge controller. For instance, assume that the controller 102 is an anti-surge controller. Each of the set of KPIs may indicate about performance of the controller 102. The set of KPIs may include duration since maintenance of the controller 102, control of pressure, overall standard deviation of the controller 102 from a set point value to the output value, overall control quality, overall service factor, and the like. For instance, standard deviation of the controller 102 may represent deviation of current value of control variable of the controller 102 from a set point of the controller 102, which is indicative of performance of the controller 102 in terms of reliability of the controller.

The system 100 may configure a user-defined analysis model based on a set of user inputs. The user-defined analysis model may, for example, enable selection of particular KPIs from the set of KPIs and for determining a singular metric corresponding to the performance of the controller 102. In an example, to configure the user-defined analysis model, the system 100 may receive the set of user inputs. The set of user inputs may indicate configuring the user-defined analysis model using default settings or based on specific inputs provided by the user. In an example, the system 100 may select the plurality of KPIs in response to the configuration of the user-defined analysis model. The selection may be done based on the user-defined analysis model.

Further, the system 100 may determine a Control Quality Index (CQI) based on the plurality of KPIs from the set of KPIs using the user-defined analysis model. In particular, the system 100 may compare the each of the plurality of KPIs with a corresponding threshold and determine the CQI based on the comparison. Subsequently, the system 100 may compare the determined CQI with a corresponding threshold value in response to the determination of the CQI. The system 100 may ascertain if the CQI is lesser than the threshold value based on the comparison. If it is ascertained that the CQI is lesser than the threshold value, the system 100 may trigger a notification indicating that the CQI is lesser than the threshold value. In addition, the system 100 may generate an action indicating corrective measures to be taken to improve performance of the controller 102. In an example, the CQI, the notification, and the action may be displayed on the device.

Although, in the above example, the system 100 is explained to monitor a single controller 102, in other example, the system 100 may monitor more than one controller, as will be explained below:

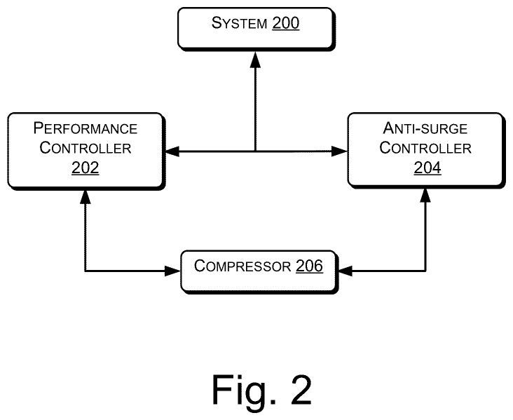

FIG. 2 illustrates a system 200 for monitoring performance of controllers 202, 204 according to an example implementation of the present subject matter. The controllers may correspond to the controllers that are configured to control a compressor 206. The controller may include two controllers, such as a performance controller 202 and an anti-surge controller 204. The compressor 206 may correspond to the compressor 106. The controllers 202, 204 may correspond to the controllers 102.

The system 200 may monitor the performance of the performance controller 202 and the anti-surge controller 204. The system 200 may be and/or may include a microprocessor, a microcomputer, a microcontroller, a digital signal processor, a central processing unit, a state machine, a logic circuitry, or a device that manipulates signals based on operational instructions. Among other capabilities, the system 200 may fetch and execute computer-readable instructions stored in a memory, such as a volatile memory or a non-volatile memory, of the system 200. The system 200 may correspond to the system 100. The system 200 may include a device (not shown in FIG. 2), such as a display device, for displaying parameters corresponding to monitoring performance of the controllers 202, 204. The monitoring of performance of the controllers 202, 204 by the system 200 is explained below.

During operation, the system 200 may obtain a first set of Key Performance Indicators (KPIs) corresponding to the performance controller 202. Each of the first set of KPIs may indicate about performance of the performance controller 202. The first set of KPIs may include duration since maintenance of the performance controller 202, control of pressure, effective service factor of the performance controller 202, standard deviation of the performance controller 202 from a set point value to the output value, overall control quality, overall service factor, an output deviation of the performance controller 202 and the like. For instance, effective service factor may indicate that the performance controller 202 in service and performs assigned functions. The effective service factor may indicate performance of the performance controller 202 in terms of availability. The standard deviation may represent deviation of current value of control variable of the controller 202 from a set point of the controller 202, which is indicative of performance of the controller 202 in terms of reliability of the controller. The output deviation may represent deviation of final control element feedback from output of the controller 202, which is indicative of performance of the performance controller 202 in terms of usability of the controller.

The system 200 may configure a first user-defined analysis model based on a first set of user inputs. The first user-defined analysis model may, for example, enable selection of particular KPIs from the first set of KPIs and for determining a singular metric corresponding to the performance of the performance controller 202. In an example, to configure the first user-defined analysis model, the system 200 may receive the first set of user inputs. The first set of user inputs may indicate configuring the first user-defined analysis model using default settings or based on specific inputs provided by the user. In an example, the system 200 may select the first plurality of KPIs in response to the configuration of the first user-defined analysis model. The selection may be done based on the first user-defined analysis model.

Further, the system 200 may determine a first CQI based on the first plurality of KPIs from the first set of KPIs using the first user-defined analysis model. In particular, the system 200 may compare each of the first plurality of KPIs with a corresponding threshold and determine the first CQI based on the comparison. Subsequently, the system 200 may compare the determined first CQI with a first threshold value in response to the determination of the first CQI. The system 200 may ascertain if the first CQI is lesser than the threshold value based on the comparison. If it is ascertained that the first CQI is lesser than the first threshold value, the system 200 may trigger a notification indicating that the first CQI is lesser than the first threshold value. In addition, the system 200 may generate a first action indicating corrective measures to be taken to improve performance of the performance controller 202. The first CQI, the first notification, and the first action may be displayed on the device.

As mentioned earlier, in addition to monitoring performance of the performance controller 202, the system 200 may monitor performance of the anti-surge controller 204. The system 200 may obtain a second set of Key Performance Indicators (KPIs) corresponding to the anti-surge controller 204. Each of the second set of KPIs may indicate about performance of the anti-surge controller 204. The second set of KPIs may include duration since maintenance of the anti-surge controller 204, control of pressure, effective service factor of the anti-surge controller 204, effectiveness of the anti-surge controller 202, overall control quality, overall service factor, an output deviation of the anti-surge controller 204 and the like. For instance, effective service factor may indicate that the anti-surge controller 204 in service and performs assigned functions. The effective service factor may indicate performance of the anti-surge controller 204 in terms of availability. The effectiveness may represent amount of time compressor was operating outside a service region, which is indicative of performance of the anti-surge controller 204 in terms of reliability of the anti-surge controller 204. The output deviation may represent deviation of final control element feedback from output of the controller 202, which is indicative of performance of the anti-surge controller 204 in terms of usability of the controller.

The system 200 may configure a second user-defined analysis model based on a second set of user inputs. The second user-defined analysis model may, for example, enable selection of particular KPIs from the second set of KPIs and for determining a singular metric corresponding to the performance of the anti-surge controller 204. In an example, to configure the second user-defined analysis model, the system 200 may receive the second set of user inputs. The second set of user inputs may indicate configuring the second user-defined analysis model using default settings or based on specific inputs provided by the user. In an example, the system 200 may select the second plurality of KPIs in response to the configuration of the second user-defined analysis model. The selection may be done based on the second user-defined analysis model.

Further, the system 200 may determine a second CQI based on the second plurality of KPIs from the second set of KPIs using the second user-defined analysis model. In particular, the system 200 may compare each of the second plurality of KPIs with a corresponding threshold and determine the second CQI based on the comparison. Subsequently, the system 200 may compare the determined second CQI with a second threshold value in response to the determination of the second CQI. The system 200 may ascertain if the second CQI is lesser than the threshold value based on the comparison. If it is ascertained that the second CQI is lesser than the second threshold value, the system 200 may trigger a notification indicating that the second CQI is lesser than the second threshold value. In addition, the system 200 may generate a second action indicating corrective measures to be taken to improve performance of the anti-surge controller 204. The second CQI, the second notification, and the second action may be displayed on the device. In an example, the system 200 may simultaneously perform functions corresponding to monitoring of the performance controller 202 and monitoring of the anti-surge controller 204.

While in the above example, the system 200 is explained to monitor the performance controller 202 and the anti-surge controller 204, in other examples, the system 200 may monitor speed controller corresponding to the compressor 206 as well.

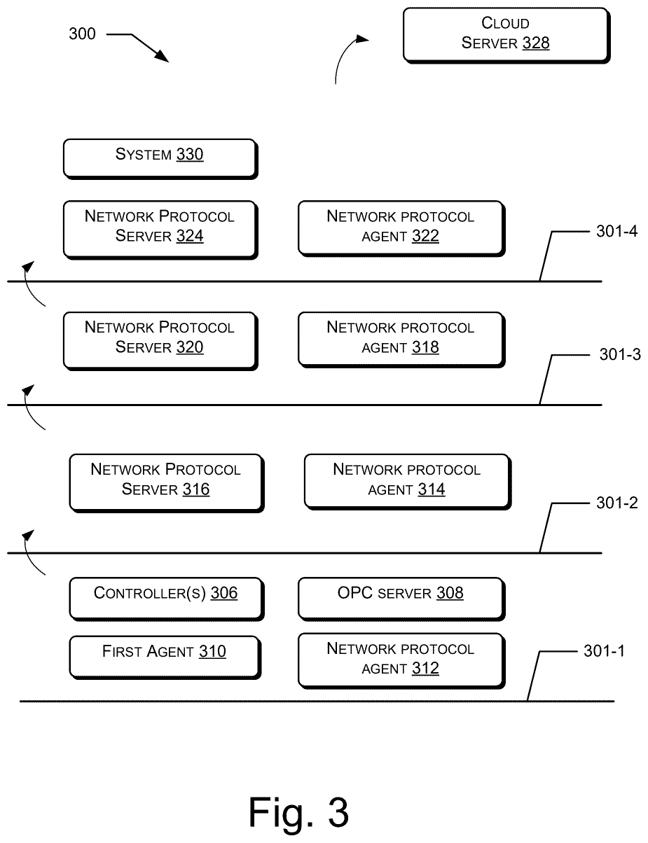

FIG. 3 illustrates a network architecture 300 corresponding to monitoring performance of controllers, according to an example implementation of the present subject matter. The network architecture 300 may correspond to an architecture for monitoring performance of controllers, such as the controllers 102, 202, or 204. The network architecture 300 may correspond to an architecture in an industrial plant, including manufacturing plants, and the like and may include a first layer 301-1, a second layer 301-2, a third layer 301-3, and fourth layer 301-4.

In an example, the first layer 301-1 may correspond to control layer that may include systems that supervise and control processes. The first layer 301-1 may correspond to Network level 2. In an example, the controllers 306 may be part of the first layer 301-1. The controllers 306 may correspond to the controller 102, the performance controller 202, or the anti-surge controller 204. In addition, the first layer 301-1 may include a first agent 310, an Open Platform Communications (OPC) server 308, and a network protocol Agent 312 for transmitting data to subsequent layers. The first agent 310 may correspond to a transfer service that is to enable transferring of data from the controllers 306 to a system 330 for monitoring performance of the controllers 306 in the fourth layer 301-4. In addition, the first layer 301-1 may include a server (not shown in FIG. 3) corresponding to the controllers 306. Further, the data in the server may include data related to surge events of the compressor, snapshot data, process data, and asset synchronization data. In other words, the data may include the KPIs, such as the first set of KPIs and the second set of KPIs. The transferring of the data from the first layer 301-1 to the second layer 301-2 may be, for example, in Secure File Transfer Protocol (SFTP).

The second layer 301-2 may correspond to the manufacturing operations systems zone and may correspond to network Level 3. The second layer 301-2 may include a network protocol server 316 and a network protocol agent 314. The network protocol server 316 may be, for example, Secure File Transfer Protocol (SFTP) Server and the network protocol agent 314 may be, for example, SFTP agent. Further, the data in the second layer 301-2 may include data related to surge events of the compressor, snapshot data, process data, and asset synchronization data that was transmitted from the first layer 301-1. The transmission of the data from the second layer 301-2 may be, for example, in SFTP. In an example, if the network share is possible between the second layer 301-2 and the fourth layer 301-4, then the second layer 301-2 may not include the network protocol server 316.

The third layer 301-3 may correspond to the Demilitarized Zone (DMZ) and may correspond to the network level 3.5. The third layer 301-3 may include may a network protocol server 320 and a network protocol agent 318. The data in the third layer 301-3 may correspond to the surge events of the compressor, snapshot data, process data, and asset synchronization data that were transmitted from the second layer 301-2. The network protocol server 320 may be, for example, Secure File Transfer Protocol (SFTP) Server and the network protocol agent 318 may be, for example, SFTP agent. The transmission of the data from the third layer 301-3 may be, for example, in SFTP.

The fourth layer 301-4 may correspond to an enterprise Zone and may correspond to the network level 4. The fourth layer 301-4 may include a network protocol server 324 and a network protocol agent 322. The network protocol server 324 may be, for example, File Transfer Protocol (SFTP) Server and the network protocol agent 322 may be, for example, SFTP agent. The fourth layer 301-4 may include the system 330 for monitoring performance of the controllers. The system 330 may correspond to the system 100 or the system 200. The system 330 may receive the data from the third layer 301-3, such as data corresponding to the surge events of the compressor, snapshot data, process data, and asset synchronization data that were transmitted from the third layer 301-3. In other words, the KPIs, such as the first set of KPIs and the second set of KPIs, may be received from the third layer 301-3.

The system 330 may be included in the fourth layer 301-4 to correspond to monitoring performance of controllers 306 on-premises of an industrial plant, including manufacturing plants, and the like. In an example, in addition to or instead of the system 330 being included in the fourth layer 301-4, a cloud server 328 may be provided to monitor performance of controllers 306 in applications, such as Software as Service Applications. The cloud server 328 may correspond to the system 100, the system 200, or the system 330. Further, the cloud server 328 may perform functions similar to the system 100, the system 200, or the system 330.

In an example, the data from the fourth layer 301-4 may be transmitted to a cloud server 328. The transmission of the data from the fourth layer 301-4 to the cloud server 328 may be, for example, in SFTP.

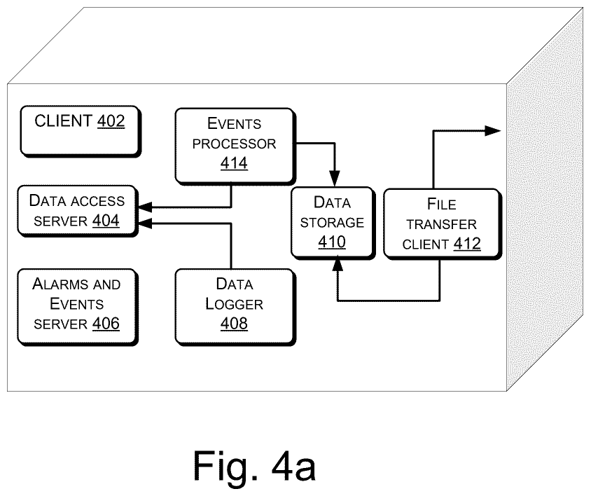

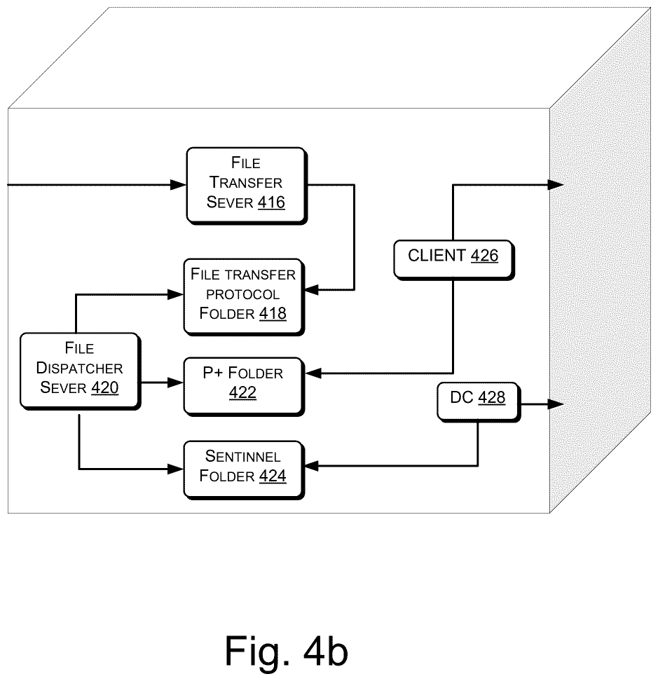

FIG. 4a illustrates components in a second level of a network architecture corresponding to monitoring performance of controllers, according to an example implementation of the present subject matter. Herein, the network level 2 is depicted. The network level 2 is a level where the controllers may be included. In this regard, the network level 2 may include an event processor 414. The event processor 414 may subscribe for event tags from the data access server 404 and may get snapshot data from the client 402. In addition, the network level 2 may include a data logger 408, which may subscribe to process data tags. The event data, the process data, and the snapshot data may be stored in the data storage 410. In other words, all data corresponding to the set of KPIs of the controllers, such as the controllers 102, the performance controller 202, the anti-surge controller 204, or the controllers 306, may be stored in the data storage 410.

The network level 2 may include a transfer service, i.e., a file transfer client 412. The file transfer client 412 may fetch the data related to the controllers, such as the event data, the process data, and the snapshot data from the data storage 410. The file transfer client 412 by fetching data may enable establishing connection of the controllers, such as the controller 102, the performance controller 202, the anti-surge controller 204, or the controllers 306 and may enable subscribing, by the transfer service, to tags of data corresponding to the set of KPIs. In particular, the network protocol used for communication may be OPC protocol. The file transfer client 412 may transmit the data including the KPIs of the controllers to the network level 4, i.e., to the system, such as the system 100, the system 200, or the system 330, in response to determining a change in data corresponding to the set of KPIs. In particular, the file transfer client 412 may transmit the set of KPIs in Comma Separated Value (CSV) format using SFTP to the system. The transmission may be through network level 3 and network level 3.5. In an example, the network level 2 may include an alarm and events server 406 to manage the alarms and events corresponding to the controllers.

FIG. 4b illustrates components in a fourth level of a network architecture corresponding to monitoring performance of controllers, according to an example implementation of the present subject matter. Herein, network level 4 is depicted. The network level 4 may include the system, such as the system 100, the system 200, or the system 330. The network level 4 may include a file transfer service 416. The file transfer service may receive the data received from the network level 2 through the network level 3. In other words, the file transfer service 416 may receive the data corresponding to the set of KPIs (event data, snapshot data, and process data) from the network level 2. The file transfer service 416 may transfer the received data to the SFTP folder 418. A file dispatcher server 420 may read the data and may transmit the data to a P+ folder 422 and to a sentinel folder 424. The P+ folder 422 may correspond to a location where files corresponding to the data are stored for uploading it to a blob storage, such as an Azure blob. The data may be used for determination of the first CQI and the second CQI. The client 426 may read the data from the P+ folder 422 and may push the data to P+ blob. A data concentrator (DC) 428 may read the data from sentinel folder 424 and push to sentinel. The data may be used for the determination of the first CQI and the second CQI.

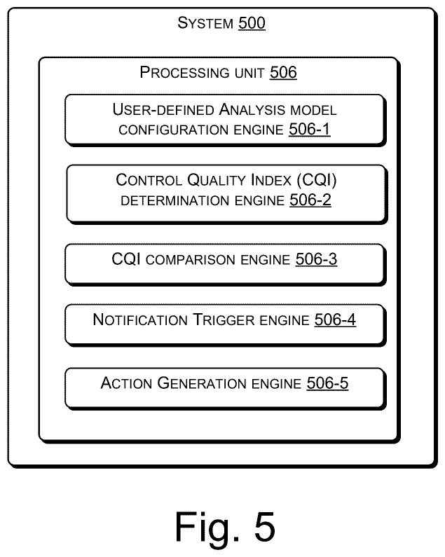

FIG. 5 illustrates a system 500 for monitoring performance of controllers, according to an example implementation of the present subject matter. The system 500 may correspond to the system 100 or the system 200. The controllers may correspond to the controllers 102, the performance controller 202, the anti-surge controller 204, and the controllers 306.

The system 500 may be a computing device that has processing capabilities, such as a server, a desktop, a laptop, a tablet, a mobile phone, or the like. For instance, the system 500 may include a processing unit 506. The processing unit 506 may be, for example, a microprocessor, a microcomputer, a microcontroller, a digital signal processor, a central processing unit, a state machine, a logic circuitry, or a device that manipulates signals based on operational instructions. Among other capabilities, the processing unit 506 may fetch and execute computer-readable instructions stored in a memory (not shown in FIG. 5), such as a volatile memory or a non-volatile memory, of the system 500.

The processing unit 506 may run at least one operating system and other applications and services. The system 500 can also include an interface (not shown in FIG. 5) and a memory (not shown in FIG. 5).

The processing unit 506, amongst other capabilities, may be configured to fetch and execute computer-readable instructions stored in the memory. The processing unit 506 may be implemented as one or more microprocessors, microcomputers, microcontrollers, digital signal processors, central processing units, state machines, logic circuitries, and/or any devices that manipulate signals based on operational instructions. The functions of the various elements shown in the figure, including any functional blocks labelled as “processing unit”, may be provided through the use of dedicated hardware as well as hardware capable of executing machine readable instructions.

When provided by the processing unit 506, the functions may be provided by a single dedicated processor, by a single shared processor, or by a plurality of individual processors, some of which may be shared. Moreover, explicit use of the term “processing unit” should not be construed to refer exclusively to hardware capable of executing machine readable instructions, and may implicitly include, without limitation, digital signal processor (DSP) hardware, network processor, application specific integrated circuit (ASIC), field programmable gate array (FPGA), read only memory (ROM) for storing machine readable instructions, random access memory (RAM), non-volatile storage. Other hardware, conventional and/or custom, may also be included.

The interface may include a variety of machine-readable instructions-based interfaces and hardware interfaces that allow the cloud communication device to interact with different entities, such as the processing unit 506, and the data. Further, the interface may enable the components of the system 500 to communicate with other cloud servers, web servers, and external repositories. The interface may facilitate multiple communications within a wide variety of networks and protocol types, including wired network, wireless networks, wireless Local Area Network (WLAN), RAN, satellite-based network, and the like.

The memory may be coupled to the processing unit 506 and may, among other capabilities, provide data and instructions for generating different requests. The memory can include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes.

Further, the system 500 may include one or more engines 506-1-506-5. The engines 506-1-506-5 may include routines, programs, objects, components, data structures, and the like, which perform particular tasks or implement particular abstract data types. Further, the engines 506-1-506-5 may be implemented in hardware, instructions executed by a processing unit, or by a combination thereof.

In an implementation, the engines 506-1-506-5 may be machine-readable instructions which, when executed by the processing unit, perform any of the described functionalities. The machine-readable instructions may be stored on an electronic memory device, hard disk, optical disk or other machine-readable storage medium or non-transitory medium. In one implementation, the machine-readable instructions can also be downloaded to the storage medium via a network connection.

The engines 506-1-506-5 may perform different functionalities. The engines 506-1-506-5 may include a user-defined analysis model configuration engine 506-1, a CQI determination engine 506-2, a CQI comparison engine 506-3, a notification trigger engine 506-4, and an action generation engine 506-5.

The user-defined analysis model configuration engine 506-1 may obtain a set of KPIs corresponding to the controllers. In an example, the user-defined analysis model may obtain a first set of KPIs corresponding to the performance controller and obtain a second set of KPIs corresponding to the anti-surge controller.

Further, the user-defined analysis model configuration engine 506-1 may configure user-defined analysis models based on a set of user inputs. In an example, the user-defined analysis model configuration engine 506-1 may define a first user-defined analysis model based on a first set of user inputs and a second user-defined analysis model based on a second set of user inputs. The first user-defined analysis model may enable determination of the first CQI corresponding to the performance controller, as explained with reference to FIG. 2. Similarly, the second user-defined analysis model may enable determination of the second CQI corresponding to the anti-surge controller, as explained with reference to FIG. 2.

In an example, the first set of user inputs may include selection of default settings for the determination of the first CQI. By the selection of the default settings, the user-defined analysis model configuration engine 506-1 may configure the first user-defined analysis model based on pre-configured settings. The pre-configured settings may include pre-configured selection of a first plurality KPIs from the first set of KPIs, pre-configured selection for threshold values corresponding to each of the selected first set of KPIs, pre-configured selection of the value of first CQI, and per-configured selection of threshold value for the first CQI. In addition, the first set of user inputs may also include selection of default settings for a first time period for the determination of the first CQI. The default settings may correspond to pre-configured selection of the first time period for the determination of the first CQI. However, in another example, the first set of user inputs may include setting of time period by a user for the determination of the first CQI.

In an example, the second set of user inputs may include selection of default settings for the determination of the second CQI. By the selection of the default settings, the user-defined analysis model configuration engine 506-1 may configure the second user-defined analysis model based on pre-configured settings. The pre-configured settings may include pre-configured selection of a second plurality KPIs from the second set of KPIs, pre-configured selection for threshold values corresponding to each of the selected second set of KPIs, pre-configured selection of the value of second CQI, and pre-configured selection of threshold value for the second CQI. In addition, the second set of user inputs may also include selection of default settings for a second time period for the determination of the second CQI. The default settings may correspond to pre-configured selection of the second time period for the determination of the second CQI. However, in another example, the second set of user inputs may include setting of time period for the determination of the second CQI by the user.

In another example, the first set of user inputs may include selecting the first plurality of KPIs from the first set of KPIs, threshold values corresponding to each of the selected first set of KPIs, the value of first CQI, and the threshold value for the first CQI by a user instead of selection of pre-configured. In addition, the first set of user inputs may also include user setting the first time period for the determination of the first CQI. Similarly, in an example, the second set of user inputs may include selecting the second plurality of KPIs from the second set of KPIs, threshold values corresponding to each of the selected second set of KPIs, the value of second CQI, and the threshold value for the second CQI by the user. In addition, the first set of user inputs may also include setting the first time period for the determination of the second CQI by the user.

The CQI determination engine 506-2 may select the plurality of KPIs based on the user-defined analysis model. In particular, the CQI determination engine may select the first plurality of KPIs based on the first user-defined analysis model and the second plurality of KPIs based on the second user-defined analysis model. In an example, the selection of the first plurality of KPIs based on the first user-defined analysis model may be selecting pre-configured first plurality of KPIs from the first set of KPIs. In another example, the selection of the first plurality of KPIs may be based on the first plurality of KPIs selected by the user from the first set of KPIs. Similarly, in an example, the selection of the second plurality of KPIs based on the second user-defined analysis model may be selecting pre-configured second plurality of KPIs from the second set of KPIs. In another example, the selection of the second plurality of KPIs may be based on the second plurality of KPIs selected by the user from the second set of KPIs.

The CQI determination engine 506-2 may determine the CQI based on the plurality of KPIs from the set of KPIs using the user-defined analysis model. The CQI may define performance of the controllers in terms of utilization of the controllers, availability of the controllers, and reliability of the controllers.

The CQI determination engine 506-2 may determine the first CQI based on the first plurality of KPIs from the first set of KPIs using the first user-defined analysis model. For the determination, the CQI determination engine 506-2 may compare each of the selected first plurality of KPIs with a corresponding threshold value and may determine the first CQI based on the comparison. In this regard, if the user had selected default settings, the first set of KPIs may include an effective service factor of the performance controller, a standard deviation of the performance controller, and an output deviation of the performance controller. The CQI determination engine 506-2 may compare the effective service factor of the controller with an effective service factor threshold, the standard deviation of the controller with a standard deviation threshold, and the output deviation of the controller with an output deviation threshold. Further, the CQI determination engine 506-2 may determine the first CQI based on the comparison the effective service factor of the controller and the effective service factor threshold, the standard deviation of the controller and the standard deviation threshold, and the output deviation of the controller and the output deviation threshold.

Using the first user-defined analysis model, the CQI determination engine 506-2 may determine the first CQI as a first value if the effective service factor of the controller is lesser than or equal to the effective service factor threshold, if the standard deviation of the controller is greater than or equal to the standard deviation threshold, and the output deviation of the controller is greater than or equal to the output deviation threshold. Similarly, using the first user-defined analysis model, the CQI determination engine 506-2 may determine the first CQI as a second value if the effective service factor of the controller is greater than the effective service factor threshold, if the standard deviation of the controller is greater than or equal to the standard deviation threshold, and the output deviation of the controller is greater than or equal to the output deviation threshold. Using the first user-defined analysis model, the CQI determination engine 506-2 may determine the first CQI as a third value if the effective service factor of the controller is greater than the effective service factor threshold, if the standard deviation of the controller is less than the standard deviation threshold, and the output deviation of the controller is less than the output deviation threshold.

The CQI determination engine 506-2 may determine the second CQI based on the second plurality of KPIs from the second set of KPIs using the second user-defined analysis model. For the determination, the CQI determination engine 506-2 may compare each of the selected second plurality of KPIs with a corresponding threshold value and may determine the second CQI based on the comparison. In this regard, if the user had selected default settings, the second set of KPIs may include an effective service factor of the anti-surge controller, an effectiveness of the anti-surge controller, and an output deviation of the anti-surge controller. The CQI determination engine 506-2 may compare the effective service factor of the controller with an effective service factor threshold, the effectiveness of the controller with an effectiveness threshold, and the output deviation of the controller with an output deviation threshold. Further, the CQI determination engine 506-2 may determine the second CQI based on the comparison the effective service factor of the controller and the effective service factor threshold, the effectiveness of the controller and the effectiveness threshold, and the output deviation of the controller and the output deviation threshold.

Using the second user-defined analysis model, the CQI determination engine 506-2 may determine the second CQI as a first value if the effective service factor of the controller is lesser than or equal to the effective service factor threshold, if the effectiveness of the controller is greater than or equal to the effectiveness threshold, and the output deviation of the controller is greater than or equal to the output deviation threshold. Similarly, using the second user-defined analysis model, the CQI determination engine 506-2 may determine the second CQI as a second value if the effective service factor of the controller is greater than the effective service factor threshold, if the effectiveness of the controller is greater than or equal to the effectiveness threshold, and the output deviation of the controller is greater than or equal to the output deviation threshold. Using the user-defined analysis model, the CQI determination engine 506-2 may determine the second CQI as a third value if the effective service factor of the controller is greater than the effective service factor threshold, if the effectiveness of the controller is less than the effectiveness threshold, and the output deviation of the controller is less than the output deviation threshold.

The CQI comparison engine 506-3 may compare the CQI with a corresponding threshold value in response to the determination of the CQI. For instance, the CQI comparison engine 506-3 may compare the first CQI with a first CQI threshold value. Similarly, the CQI comparison engine 506-3 may compare the second CQI with the second CQI threshold value. The CQI comparison engine 506-3 may use the first user-defined analysis model for the comparison of the first CQI with the first CQI threshold value and may use the second user-defined analysis model for the comparison of the second CQI with the second user-defined analysis model. Further, the CQI comparison engine 506-3 may ascertain if the CQI is equal to or lesser than the corresponding threshold value based on the comparison. For instance, the CQI comparison engine 506-3 may ascertain if the first CQI is equal to or lesser than the first CQI threshold value. Similarly, the CQI comparison engine 506-3 may ascertain if the second CQI is equal to or lesser than the second CQI threshold value.

The notification trigger engine 506-4 may trigger a notification indicating that the CQI is lesser than the threshold value based on the ascertaining that the CQI is lesser than the threshold value. In an example, the notification trigger engine 506-4 may trigger a first notification indicating that the first CQI is lesser than the first CQI threshold value. Similarly, the notification trigger engine 506-4 may trigger a second notification indicating that the second CQI is lesser than the second CQI threshold value.

The action generation engine 506-5 may generate an action indicating corrective measures to be taken to improve the performance of the controllers based on the ascertaining that the CQI is lesser than the corresponding threshold value. For instance, the action generation engine 506-5 may generate a first action indicating corrective measures to be taken to improve the performance of the performance controller. The action generation engine 506-5 may generate a second action indicating corrective measures to be taken to improve the performance of the anti-surge controller.

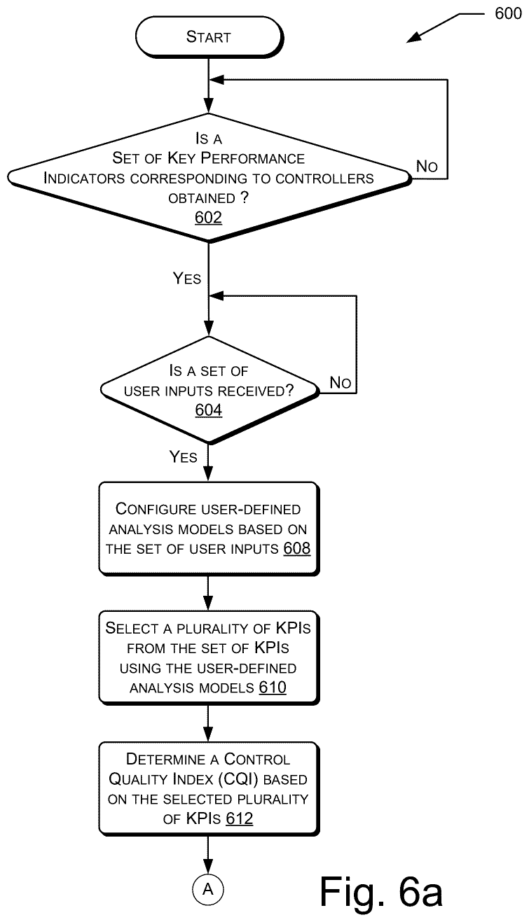

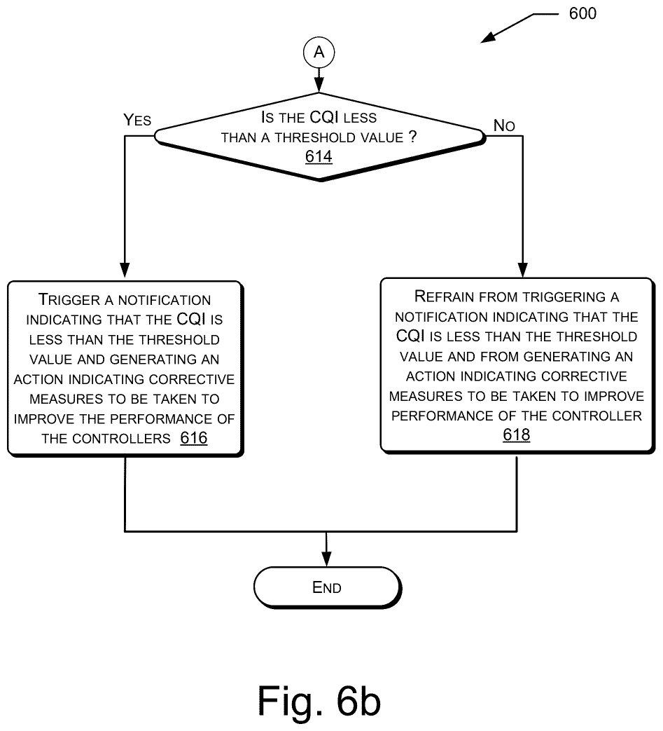

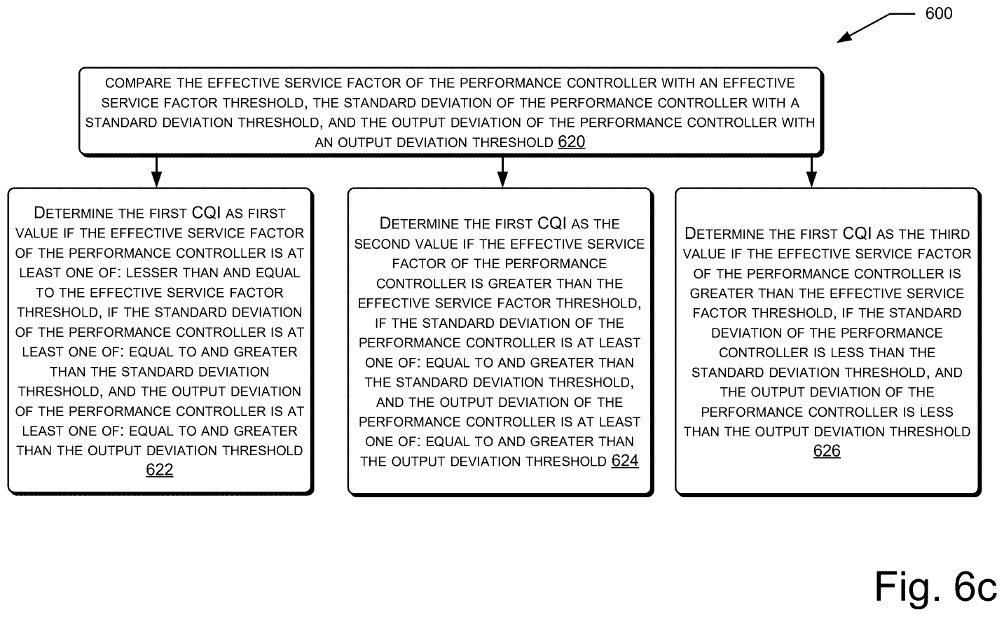

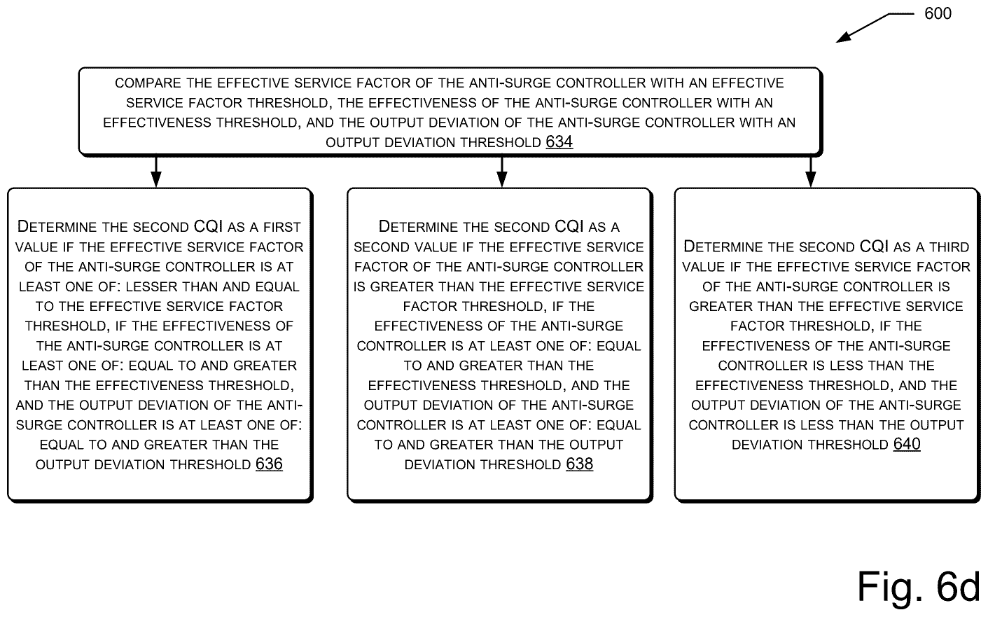

FIGS. 6a-6d illustrate a method 600 for monitoring performance of controllers, according to an example implementation of the present subject matter. The order in which the method 600 is described is not intended to be construed as a limitation, and any number of the described method blocks may be combined in any order to implement the method 600, or an alternative method. Furthermore, the method 600 may be implemented by processor(s) or computing device(s) through any suitable hardware, non-transitory machine-readable instructions, or a combination thereof.

It may be understood that steps of the method 600 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, the method 600 may be performed by the system 100, the system 200, the system 330, or the system 500. The controllers may correspond to the controllers 102, the controllers 306, the performance controller 202, or the anti-surge controller 204. Hereinafter, the method 600 will be explained with reference to monitoring performance of two controllers, a performance controller and an anti-surge controller.

Referring to FIG. 6a, at step 602, it may be determined if a set of KPIs corresponding to the controllers is obtained from the controllers. For instance, it may be determined if a first set of KPIs corresponding to the performance controller is received from the performance controller. The first set of KPIs may, for example, include an effective service factor of the performance controller, duration since maintenance of the performance controller, control of pressure, standard deviation of the performance controller, overall control quality, overall service factor, deviation of the performance controller, and the like. Similarly, it may be determined if a second set of KPIs corresponding to the anti-surge controller is obtained from the anti-surge controller. The second set of KPIs may, for example, include an effective service factor of the anti-surge controller, duration since maintenance of the anti-surge controller, control of pressure, effectiveness of the anti-surge controller, overall control quality, overall service factor, deviation of the anti-surge controller, and the like. The obtaining of the first set of KPIs and the second set of KPIs from the corresponding controllers will be performed as explained with reference to FIG. 3, FIG. 4a, and FIG. 4b.

If, at step 602, it is determined that the set of KPIs is not received, the method 600 may keep performing step 602 till the set of KPIs is obtained. On the other hand, if the set of KPIs are obtained, the method 600 may proceed to step 604.

At step 604, it may be determined if a set of user inputs is received. In particular, it may be determined if a first set of user inputs and a second set of user inputs are received. The first set of user inputs may correspond to the performance controller and the second set of user inputs may correspond to the anti-surge controller.

In an example, the first set of user inputs may correspond to selection of default settings by a user. The default settings may include pre-configured selection of a first plurality of KPIs from the first set of KPIs. Further, the default settings may also include threshold values corresponding to each of the first plurality of KPIs. In addition, the first set of user inputs may also correspond to selection of default setting of a first time period. However, in another example, the first set of user inputs may include setting of first time period by a user.

In another example, the first set of user inputs may correspond to selection of first plurality of KPIs from the first set of KPIs by the user, selection of threshold values corresponding to each of the first plurality of KPIs by the user. In addition, the first set of user inputs may also correspond to setting of the first time period by the user. Hereinafter, the first set of user inputs may be explained with reference to selection of default setting by the user.

In an example, the second set of user inputs may correspond to selection of default settings by a user. The default settings may include pre-configured selection of a second plurality of KPIs from the second set of KPIs. Further, the default settings may also include threshold values corresponding to each of the second plurality of KPIs. In addition, the second set of user inputs may also correspond to selection of default setting of a second time period. However, in another example, the second set of user inputs may include setting of time period by a user.

In another example, the second set of user inputs may correspond to selection of the second plurality of KPIs from the second set of KPIs by the user, selection of threshold values corresponding to each of the second plurality of KPIs by the user. In addition, the second set of user inputs may also correspond to setting of the second time period by the user. Hereinafter, the second set of user inputs may be explained with reference to selection of default setting by the user.

If, at step 604, it is determined that the first set of user inputs and the second set of user inputs are received, the method 600 may proceed to step 608. On the other hand, if it is determined that the first set of user inputs and the second set of user inputs are not received, the method 600 may repeat step 604.

At step 608, the user-defined analysis models, such as a first user-defined analysis model and a second user-defined analysis model, may be configured based on the set of user inputs, such as the first set of user inputs and the second set of user inputs respectively. The first user-defined analysis model may correspond to the performance controller. The second user-defined analysis model may correspond to the performance controller.

The configuration of the first user-defined analysis model may correspond to fixing of the first plurality of KPIs that are to be selected from the first set of KPIs, fixing of threshold values corresponding to each of the selected KPIs, and fixing of the first time period based on the default settings. For instance, assume that the first set of KPIs includes an effective service factor of the performance controller, duration since maintenance of the performance controller, control of pressure, standard deviation of the performance controller, overall control quality, overall service factor, deviation of the performance controller, and the like. Further, assume that in the default settings, the first plurality of KPIs that are to be selected is the effective service factor of the performance controller, the standard deviation of the performance controller, and the deviation of the performance controller. In addition, assume that, in the default settings, the effective service factor threshold is 90, the standard deviation threshold is 1, and the deviation threshold is 1. Assume that the first time period in the default settings is 30 days. In this regard, the first user-defined analysis model may be configured by fixing the first plurality of KPIs as the effective service factor of the performance controller, the standard deviation of the performance controller, and the deviation of the performance controller. Further, the configuration of the first user-defined analysis may also include fixing of the effective service factor threshold as 90, the standard deviation threshold as 1, and the deviation threshold as 1. Yet further, the configuration of the first user-defined analysis model may include fixing of the first time period as 30 days.

The configuration of the second user-defined analysis model may correspond to fixing of the second plurality of KPIs that are to be selected from the second set of KPIs, fixing of threshold values corresponding to each of the selected KPIs, and fixing of the second time period. For instance, assume that the second set of KPIs includes an effective service factor of the anti-surge controller, duration since maintenance of the anti-surge controller, effectiveness of the anti-surge controller, overall control quality, overall service factor, deviation of the anti-surge controller, and the like. Further, assume that in the default settings, the second plurality of KPIs that are to be selected is the effective service factor of the anti-surge controller, the effectiveness of the anti-surge controller, and the deviation of the anti-surge controller. In addition, assume that the effective service factor threshold is 90, the effectiveness threshold is 1, and the deviation threshold is 1 based on the default settings. Assume that the second time period in the default settings is 30 days. In this regard, the second user-defined analysis model may be configured by fixing the second plurality of KPIs as the effective service factor of the anti-surge controller, the effectiveness of the anti-surge controller, and the deviation of the anti-surge controller. Further, the configuration of the second user-defined analysis may also include fixing of the effective service factor threshold as 90, the effectiveness as 1, and the deviation threshold as 1. Yet further, the configuration of the second user-defined analysis model may include fixing of the second time period as 30 days.

At step 610, the plurality of KPIs from the set of KPIs may be selected using the user-defined analysis model. In other words, the first plurality of KPIs may be selected from the first set of KPIs using the first user-defined analysis model. For instance, based on the first user-defined analysis model, the effective service factor of the performance controller, the standard deviation of the performance controller, and the deviation of the performance controller may be selected as the first plurality of KPIs from the first set of KPIs.

The second plurality of KPIs may be selected from the second set of KPIs using the second user-defined analysis mode. In other words, the second plurality of KPIs may be selected from the second set of KPIs using the second user-defined analysis model. For instance, based on the second user-defined analysis model, the effective service factor of the anti-surge controller, the effectiveness of the anti-surge controller, and the output deviation of the anti-surge controller may be selected as the second plurality of KPIs from the second set of KPIs.

At step 612, a Control Quality Index (CQI) may be determined based on the selected plurality of KPIs using the user-defined analysis model. The CQI may define performance of the controllers in terms of utilization of the controller, availability of the controller, and reliability of the controller. In an example, a first CQI may be determined based on the first selected plurality of KPIs using the first user-defined analysis model. For the determination of the first CQI, the selected KPIs may be compared with the corresponding threshold values. For instance, the effective service factor of the performance controller may be compared with the effective service factor threshold, the standard deviation of the performance controller may be compared with the standard deviation threshold, and the output deviation of the performance controller may be compared with an output deviation threshold. The first CQI may be determined based on the comparison, as will be explained with reference to FIG. 6c. Assume that the effective service factor of the performance controller is 89, the standard deviation of the performance controller is 0.8, and the output deviation of the performance controller is 0.7. For the determination of the first CQI, the value of 89 may be compared with the effective service factor threshold value of 90, the value of 0.8 may be compared with the standard deviation threshold value of 1, and the value of 0.7 may be compared with the deviation threshold value of 1 using the first user-defined analysis model. In an example, the first CQI may be determined for the first time period as set in the first-user defined analysis model.

In an example, a second CQI may be determined based on the second selected plurality of KPIs using the second user-defined analysis model. For the determination of the second CQI, the selected KPIs may be compared with the corresponding threshold values. For instance, the effective service factor of the anti-surge controller may be compared with the effective service factor threshold, the effectiveness of the anti-surge controller may be compared with the effectiveness threshold, and the output deviation of the anti-surge controller may be compared with an output deviation threshold. The second CQI may be determined based on the comparison, as will be explained with reference to FIG. 6d. Assume that the effective service factor of the anti-surge controller is 89, the effectiveness of the anti-surge controller is 0.8, and the output deviation of the anti-surge controller is 0.7. For the determination of the second CQI, the value of 89 may be compared with the effective service factor threshold value of 90, the value of 0.8 may be compared with the effectiveness threshold value of 1, and the value of 0.7 may be compared with the deviation threshold value of 1 using the second user-defined analysis model. In an example, the second CQI may be determined for the second time period as set in the first-user defined analysis model.

Referring to FIG. 6b, at step 614, the determined CQI may be compared with a corresponding threshold value. In other words, the determined first CQI may be compared with a first threshold value. In this regard, the default settings may include preset threshold value corresponding to the first CQI and the configuring of the first user-defined analysis model may include fixing of the preset threshold value as the first threshold value corresponding to the CQI. In another example, the user may set the threshold value corresponding to the CQI. Accordingly, the configuring of the first user-defined analysis model may include fixing of the threshold value corresponding to the first CQI that is set by the user as the first threshold value.

In another example, the determined second CQI may be compared with a second threshold value. In this regard, the default settings may include preset threshold value corresponding to the second CQI and the configuring of the second user-defined analysis model may include fixing of the preset threshold value as the second threshold value corresponding to the second CQI. In an example, the user may set the threshold value corresponding to the second CQI. Accordingly, the configuring of the second user-defined analysis model may include fixing of the threshold value corresponding to the second CQI that is set by the user as the second threshold value.

If, at step 614, it is ascertained that the determined CQI is lesser than the corresponding threshold value, the method 600 may proceed to step 616. On the other hand, if, at step 614, it is ascertained that the determined CQI is not lesser than the corresponding threshold value, the method 600 may proceed to step 618.

At step 616, a notification indicating that the CQI is less than the threshold value may be triggered based on the ascertaining that the CQI is less than the first threshold value. In addition, an action may be generated indicating corrective measures to be taken to improve the performance of the controllers. In an example, based on the ascertaining that the first CQI is less than the threshold value, a first notification indicating that the first CQI is less than the first threshold value may be triggered and a first action indicating corrective measures to improve the performance of the performance controller may be generated. For instance, assume that the first CQI is 2 and the first threshold value is 3. In this regard, it may be ascertained that the first CQI is less than the first threshold value based on the comparison. Further, a first notification indicating that the first CQI (2) is less than the first threshold value (3) may be triggered. In addition, a second action indicating corrective measures to be taken to improve the performance of the performance controller may be generated. The action may be, for example, to improve response of a main Proportional-Integral-Derivative (PID) loop.

In an example, based on the ascertaining that the second CQI is less than the second threshold value, a second notification indicating that the second CQI is less than the second threshold value may be triggered and a second action indicating corrective measures to improve the performance of the anti-surge controller may be generated. For instance, assume that the second CQI is 1 and the second threshold value is 3. In this regard, it may be ascertained that the second CQI is less than the second threshold value based on the comparison. Further, a second notification indicating that the second CQI (2) is less than the second threshold value (1) may be triggered. In addition, a second action indicating corrective measures to be taken to improve the performance of the anti-surge controller may be generated. The second action may be, for example, to improve response of a main PID loop by the anti-surge controller.

At step 618, based on the ascertaining that the CQI is not less the threshold value, triggering the notification indicating that the CQI is less than the threshold value may be refrained from and generating an action to be taken to improve the performance of the controllers may be refrained from. In addition, it may be refrained from generating an action indicating corrective measures to be taken to improve the performance of the controllers. For instance, based on the ascertaining that the first CQI is not less than the first threshold value, it may be refrained from triggering the first notification and generating the first action. Assume that the first CQI is 3 and the first threshold value is 3. Based on the ascertaining that the first CQI (3) is not less than the first threshold value (3), the first notification may not be triggered and the first action may not be generated. In an example, the second CQI, the second notification, and the second action may be displayed on a device.

For instance, based on the ascertaining that the second CQI is not less than the second threshold value, it may be refrained from triggering the second notification and generating the second action. Assume that the second CQI is 3 and the second threshold value is 3. Based on the ascertaining that the second CQI (3) is not less than the second threshold value (3), the second notification may not be triggered and the second action may not be generated. In an example, the second CQI, the second notification, and the second action may be displayed on a device.

As mentioned earlier, for the determination of the first CQI (i.e., for the performance controller), the first plurality of selected KPIs be compared with the corresponding threshold values. The determination of the first CQI will be explained as follows.

In an example, the default settings for the determination of the first CQI may include an effective service factor of the performance controller, a standard deviation of the performance controller, and an output deviation of the performance controller that are to be selected as first plurality of KPIs from the first set of KPIs. This is because the effective service factor may indicate performance of the performance controller in terms of the availability. The standard deviation of the performance controller may indicate performance of the performance controller in terms of the reliability. The output deviation may indicate performance of the performance controller in terms of utilization. Further, the default settings may also include an effective service factor threshold, the standard deviation threshold, and the output deviation threshold. In an example, the effective service factor threshold may be, for example, 90. The standard deviation threshold may be, for example, 1, The output deviation threshold may be, for example, 1. In addition, the default setting may include the time period for the determination of the first CQI as 30 days.

In this regard, the first user-defined analysis model may be configured by fixing the first plurality of KPIs as the effective service factor of the performance controller, the standard deviation of the performance controller, and the output deviation of the performance controller. Further, the first user-defined analysis model may be configured by fixing the effective service factor threshold as 90, the standard deviation threshold as 1, and the output deviation threshold as 1. In addition, the first user-defined analysis model may be configured by fixing the first time period as 30 days.

At step 620, using the first user-defined analysis model, the effective service factor of the performance controller may be compared with the effective service factor threshold, the standard deviation of the performance controller may be compared with the standard deviation threshold, and the output deviation of the performance controller may be compared with the output deviation threshold.

At step 622, the first CQI may be determined as the first value if the effective service factor of the performance controller is lesser than or equal to the effective service factor threshold, if the standard deviation of the performance controller is greater than or equal than the standard deviation threshold, and the output deviation of the performance controller is greater than or equal to the output deviation threshold. For instance, assume that the effective service factor threshold of the performance controller is 85, the standard deviation of the performance controller is 1.2, and the output deviation of the performance controller is 1.3. In this regard, it may be determined that the first CQI as the first value since the effective service factor of the performance controller is lesser than the effective service factor threshold, the standard deviation of the performance controller is greater than the standard deviation threshold, and the output deviation of the performance controller is greater than the output deviation threshold. In an example, the first value may be 1 and may indicate poor status of the performance controller.

At step 624, the first CQI may be determined as a second value if the effective service factor of the performance controller is greater than the effective service factor threshold, if the standard deviation of the performance controller is greater than or equal to the standard deviation threshold, and the output deviation of the performance controller is greater than or equal to the output deviation threshold. For instance, assume that the effective service factor threshold of the performance controller is 92, the standard deviation of the performance controller is 1, and the output deviation of the performance controller is 1.1. In this regard, it may be determined that the first CQI as the second value since the effective service factor of the performance controller is greater than the effective service factor threshold, the standard deviation of the performance controller is equal to the standard deviation threshold, and the output deviation of the performance controller is greater than the output deviation threshold. In an example, the second value may be 2 and may indicate bad status of the performance controller.

At step 626, the first CQI may be determined as a third value if the effective service factor of the performance controller is greater than the effective service factor threshold, if the standard deviation of the performance controller is less than the standard deviation threshold, and the output deviation of the performance controller is less than the output deviation threshold. For instance, assume that the effective service factor threshold of the performance controller is 92, the standard deviation of the performance controller is 0.8, and the output deviation of the performance controller is 0.7. In this regard, it may be determined that the first CQI as the third value since the effective service factor of the performance controller is greater than the effective service factor threshold, the standard deviation of the performance controller is less than the standard deviation threshold, and the output deviation of the performance controller is less than the output deviation threshold. In an example, the third value may be 3 and may indicate good status of the performance controller. The third value may be the first threshold value against which the determined first CQI may be compared to as explained with reference to FIG. 6a. In an example, the first CQI may be determined for the time period of 30 days. As mentioned earlier, upon determining the first CQI, the first CQI may be compared with the first threshold value and the first notification and the first action may generated accordingly. In an example, the first action may be to provide instructions to address issue by coordinating with subject matter experts corresponding to the performance controller. For instance, performance and responses of a main PID loop and other PID loops, such as alternate PID loops, limiting PID loops, corresponding to the performance controller may be analyzed. When it is determined that the first CQI is bad or poor, the first notification indicating the first CQI is bad or poor may be generated. Further, the first notification may also include whether the main PID loop or the other PID loops are not performing efficiently. Further, the first action recommending improving performance of the main PID loop or the other PID loops may be generated. Based on the first notification, users may be able to identify if there are any issues with the main PID loops or other PID loops. Further, based on the first action, the issue may be addressed by coordinating with appropriate personnel, such as a subject matter expert (SME).

As mentioned earlier, for the determination of the second CQI (i.e., for the anti-surge controller), the second plurality of selected KPIs be compared with the corresponding threshold values. The determination of the second CQI will be explained as follows.

In an example, the default settings for the determination of the second CQI may include an effective service factor of the anti-surge controller, an effectiveness of the anti-surge controller, and an output deviation of the anti-surge controller that are to be selected as second plurality of KPIs from the second set of KPIs. This is because the effective service factor may indicate performance of the anti-surge controller in terms of the availability. The effectiveness of the anti-surge controller may indicate performance of the anti-surge controller in terms of the reliability. The output deviation may indicate performance of the anti-surge controller in terms of utilization. Further, the default settings may also include an effective service factor threshold, the effectiveness threshold, and the output deviation threshold. In an example, the effective service factor threshold may be, for example, 90. The effectiveness threshold may be, for example, 1, The output deviation threshold may be, for example, 1. In addition, the default setting may include the time period for the determination of the second CQI as 30 days.

In this regard, the second user-defined analysis model may be configured by fixing the second plurality of KPIs as the effective service factor of the anti-surge controller, the effectiveness of the anti-surge controller, and the output deviation of the anti-surge controller. Further, the second user-defined analysis model may be configured by fixing the effective service factor threshold as 90, the effectiveness threshold as 1, and the output deviation threshold as 1. In addition, the second user-defined analysis model may be configured by fixing the second time period as 30 days.

At step 634, using the second user-defined analysis model, the effective service factor of the anti-surge controller may be compared with the effective service factor threshold, the effectiveness of the anti-surge controller may be compared with the effectiveness threshold, and the output deviation of the anti-surge controller may be compared with the output deviation threshold.

At step 636, the second CQI may be determined as the first value if the effective service factor of the anti-surge controller is lesser than or equal to the effective service factor threshold, if the effectiveness of the anti-surge controller is greater than or equal than the effectiveness threshold, and the output deviation of the anti-surge controller is greater than or equal to the output deviation threshold. For instance, assume that the effective service factor threshold of the anti-surge controller is 87, the effectiveness of the anti-surge controller is 1.5, and the output deviation of the anti-surge controller is 1.1. In this regard, it may be determined that the second CQI as the second value since the effective service factor of the anti-surge controller is lesser than the effective service factor threshold, the effectiveness of the anti-surge controller is greater than the effectiveness threshold, and the output deviation of the anti-surge controller is greater than the output deviation threshold. In an example, the second value may be 1 and may indicate poor status of the anti-surge controller.

At step 638, the second CQI may be determined as a second value if the effective service factor of the anti-surge controller is greater than the effective service factor threshold, if the effectiveness of the anti-surge controller is greater than or equal to the effectiveness threshold, and the output deviation of the anti-surge controller is greater than or equal to the output deviation threshold. For instance, assume that the effective service factor threshold of the anti-surge controller is 93, the effectiveness of the anti-surge controller is 1.1, and the output deviation of the anti-surge controller is 1. In this regard, it may be determined that the second CQI as the second value since the effective service factor of the anti-surge controller is greater than the effective service factor threshold, the effectiveness of the anti-surge controller is greater than the effectiveness threshold, and the output deviation of the anti-surge controller is equal to the output deviation threshold. In an example, the second value may be 2 and may indicate bad status of the anti-surge controller.

At step 640, the second CQI may be determined as a third value if the effective service factor of the anti-surge controller is greater than the effective service factor threshold, if the effectiveness of the anti-surge controller is less than the effectiveness threshold, and the output deviation of the anti-surge controller is less than the output deviation threshold. For instance, assume that the effective service factor threshold of the anti-surge controller is 95, the effectiveness of the anti-surge controller is 0.5, and the output deviation of the anti-surge controller is 0.5. In this regard, it may be determined that the second CQI as the third value since the effective service factor of the anti-surge controller is greater than the effective service factor threshold, the effectiveness of the anti-surge controller is less than the effectiveness threshold, and the output deviation of the anti-surge controller is less than the output deviation threshold. In an example, the third value may be 3 and may indicate good status of the anti-surge controller. The third value may be the second threshold value against which the determined second CQI may be compared to as explained with reference to FIG. 6a.

As mentioned earlier, upon determining the second CQI, the second CQI may be compared with the second threshold value and the second notification and the second action may generated accordingly. In an example, the second action may be to provide instructions to address issue by coordinating with subject matter experts corresponding to the performance controller. For instance, performance and responses of a main PID loop and other PID loops, such as alternate PID loops, limiting PID loops, corresponding to the anti-surge controller may be analyzed. When it is determined that the second CQI is bad or poor, the second notification indicating the second CQI is bad or poor may be generated. Further, the second notification may also include whether the main PID loop or the other PID loops are not performing efficiently. Further, the second action recommending improving performance of the main PID loop or the other PID loops may be generated. Based on the second notification, users may be able to identify if there are any issues with the main PID loops or other PID loops. Further, based on the second action, the issue may be addressed by coordinating with appropriate personnel, such as a subject matter expert (SME).

In the above examples, the first set of user inputs and the second set of user inputs were explained with reference to selection of the default settings. However, in other examples, the first set of user inputs may include selection of the first plurality of KPIs from the first set of KPIs by the user. Further, the first set of user inputs may also include the selection of thresholds corresponding to each of the first plurality of KPIs and setting of the first time period by the user. In addition, the first set of user inputs may also include the selection of first threshold value corresponding to the first CQI by the user. Based on the above-mentioned selection by the user, the first user-defined analysis model may be configured, as explained with reference to FIG. 6a.

Similarly, in other examples, the second set of user inputs may include selection of the second plurality of KPIs from the second set of KPIs by the user. Further, the second set of user inputs may also include the selection of thresholds corresponding to each of the second plurality of KPIs and setting of the second time period by the user. In addition, the second set of user inputs may also include the selection of second threshold value corresponding to the second CQI by the user. Based on the above-mentioned selection by the user, the second user-defined analysis model may be configured, as explained with reference to FIG. 6a.

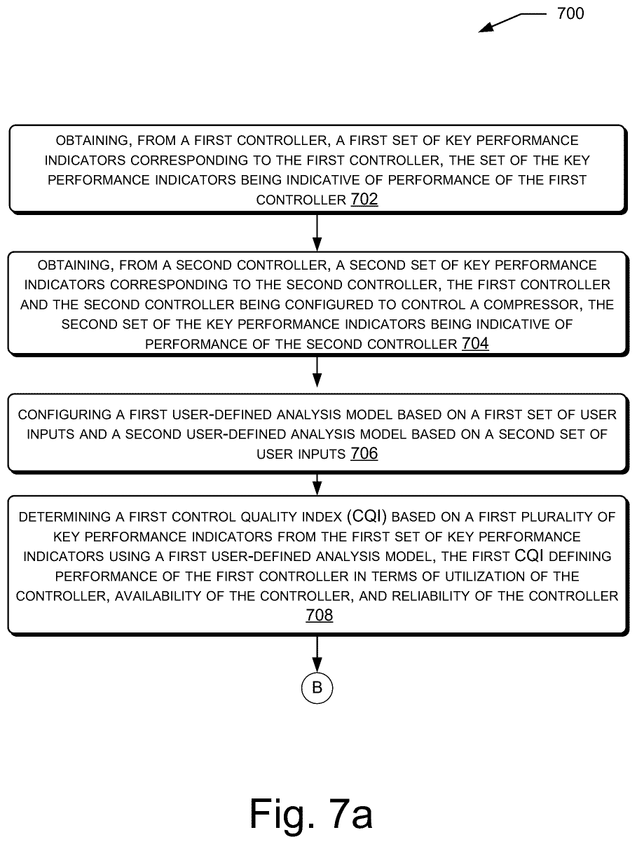

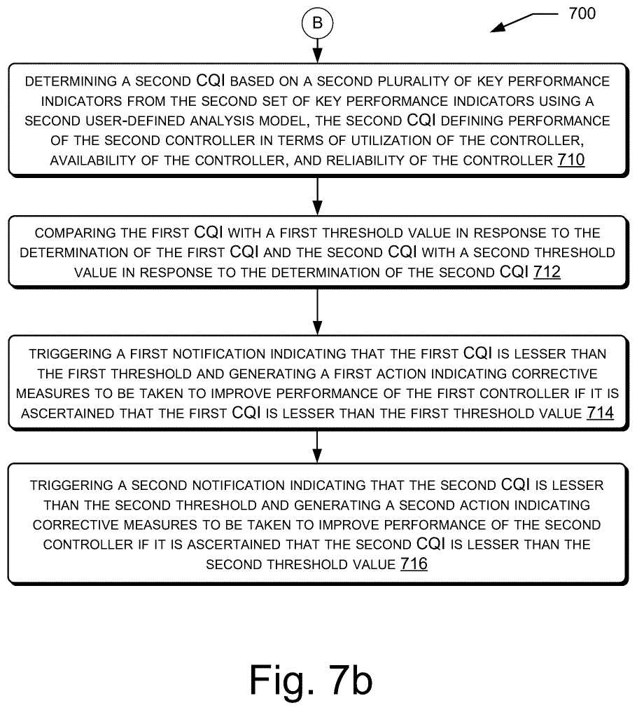

FIGS. 7a-7b illustrate a method 700 for monitoring performance of controllers, according to an example implementation of the present subject matter. The order in which the method 700 is described is not intended to be construed as a limitation, and any number of the described method blocks may be combined in any order to implement the method 700, or an alternative method. Furthermore, the method 700 may be implemented by processor(s) or computing device(s) through any suitable hardware, non-transitory machine-readable instructions, or a combination thereof.

It may be understood that steps of the method 700 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, the method 700 may be performed by the system 100, the system 200, the system 330, or the system 500.

Referring to FIG. 7a, at step 702, a first set of KPIs corresponding to a first controller from the first controller. The first set of the KPIs may be indicative of performance of the first controller. The first controller may be configured to control a compressor. The compressor may correspond to the compressor 106 or the compressor 206. The first controller may correspond to the controller 102, the controllers 306, the performance controller 202, or the anti-surge controller 204.

At step 704, a second set of KPIs corresponding to a second controller from the second controller. The second controller may be configured to control the compressor. The second set of the KPIs may be indicative of performance of the second controller. The second controller may correspond to the controller 102, the controllers 306, the performance controller 202, or the anti-surge controller 204.

At step 706, a first user-defined analysis model may be configured based on a first set of user inputs and a second user-defined analysis model may be configured based on a second set of user inputs. The configuration of the first user-defined analysis model and the configuration of the second user-defined analysis model may be performed as explained with reference to FIG. 6a.

At step 708, a first CQI based on a first plurality of KPIs from the first set of KPIs may be determined using the first user-defined analysis model. The first CQI may define performance of the first controller in terms of utilization of the first controller, availability of the first controller, and reliability of the first controller. The determination of the first CQI may be done as explained with reference to FIG. 6c.

Referring to FIG. 7b, at step 710, a second CQI based on a second plurality of KPIs from the second set of KPIs using the second user-defined analysis model. The second CQI may define performance of the second controller in terms of utilization of the second controller, availability of the second controller, and reliability of the second controller. The determination of the second CQI may be done as explained with reference to FIG. 6d.

At step 712, the first CQI may be compared with a first threshold value in response to the determination of the first CQI. Similarly, the second CQI may be compared with a second threshold value in response to the determination of the second CQI. At step 714, a first notification indicating that the first CQI is lesser than the first threshold value may be triggered and a first action indicating corrective measures to be taken to improve performance of the first controller may be generated if it is ascertained that the first CQI is lesser than the first threshold value.

At step 716, a second notification indicating that the second CQI is lesser than the second threshold value may be triggered and a second action indicating corrective measures to be taken to improve performance of the second controller may be generated if it is ascertained that the second CQI is lesser than the second threshold value.

The method 700 may include selecting, based on the first user-defined analysis model, the first plurality of key performance indicators from the first set of key performance indicators and selecting, based on the second user-defined analysis model, the second plurality of key performance indicators from the second set of key performance indicators.

When the first controller is a performance controller, the first plurality of KPIs may include an effective service factor of the first controller, a standard deviation of the first controller, and an output deviation of the first controller. The method 700 may include comparing, using the first user-defined analysis model, the effective service factor of the first controller with an effective service factor threshold, the standard deviation of the first controller with a standard deviation threshold, and the output deviation of the first controller with an output deviation threshold. The first CQI may be compared based on the comparison the effective service factor of the first controller and the effective service factor threshold, the standard deviation of the first controller and the standard deviation threshold, and the output deviation of the first controller and the output deviation threshold.

When the second controller is an anti-surge controller, the second plurality of KPIs may include an effective service factor of the second controller, an effectiveness of the second controller, and an output deviation of the second controller. The method 700 may include comparing, using the second user-defined analysis model, the effective service factor of the second controller with an effective service factor threshold, the effectiveness of the second controller with an effectiveness threshold, and the output deviation of the second controller with an output deviation threshold. Further, the second CQI may be determined based on the comparison the effective service factor of the second controller and the effective service factor threshold, the effectiveness of the second controller and the effectiveness threshold, and the output deviation of the second controller and the output deviation threshold.

In an example, the method 700 may include determining, by using the second user-defined analysis model, the second CQI as a first value if the effective service factor of the second controller is lesser than or equal to the effective service factor threshold, if the effectiveness of the second controller is greater than or equal to the effectiveness threshold, and the output deviation of the second controller is greater than or equal to the output deviation threshold. The second CQI may be determined as a second value using the second user-defined analysis model if the effective service factor of the second controller is greater than the effective service factor threshold, if the effectiveness of the second controller is greater than or equal to the effectiveness threshold, and the output deviation of the second controller is greater than or equal to the output deviation threshold. The method 700 may include determining, by using the second user-defined analysis model, the second CQI as a third value if the effective service factor of the second controller is greater than the effective service factor threshold, if the effectiveness of the second controller is less than the effectiveness threshold, and the output deviation of the second controller is less than the output deviation threshold, wherein the third value being the threshold value. The third value may be the second threshold value.

The obtaining of the first set of KPIs from the first controller may include establishing connection, by using the transfer service, with the first controller. Tags of data corresponding to the first set of KPIs may be subscribed by the transfer service using OPC protocol. The first set of KPIs may be pulled in response to determining a change in data corresponding to the first set of KPIs. The first set of KPIs may be transmitted by the transfer service in Comma Separated Value (CSV) format using SFTP. The obtaining of the second set of KPIs from the second controller may include establishing connection, by using the transfer service, with the second controller. Tags of data corresponding to the second set of KPIs may be subscribed by the transfer service using OPC protocol. The second set of KPIs may be pulled in response to determining a change in data corresponding to the second set of KPIs. The second set of KPIs may be transmitted by the transfer service in CSV format using SFTP.

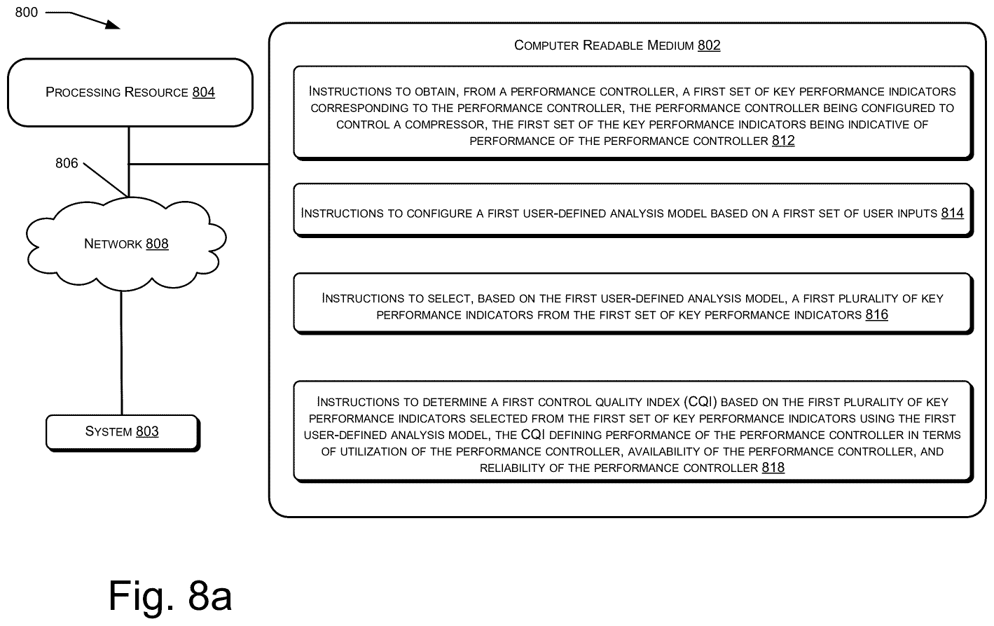

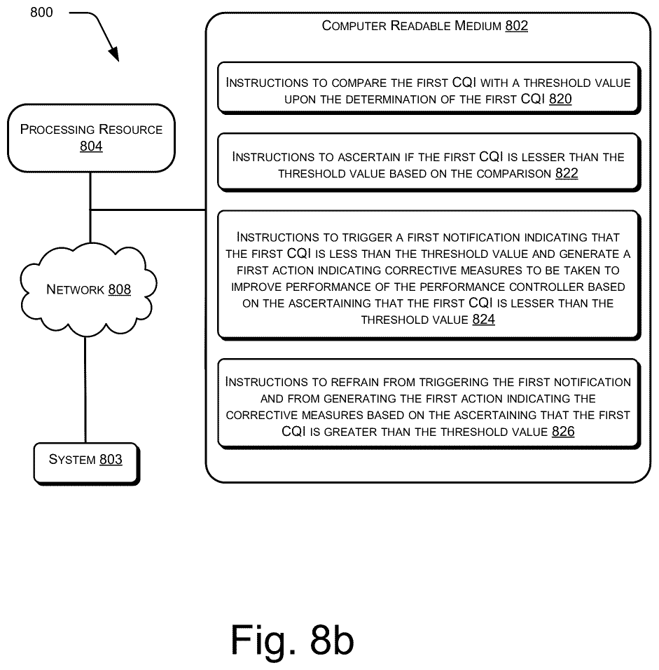

FIGS. 8a-8b illustrate a computing environment 800, implementing a non-transitory computer-readable medium for monitoring performance of controllers, according to an example implementation of the present subject matter.

In an example, the non-transitory computer-readable medium 802 may be utilized by the system 803. The system 803 may correspond to the system 100, the system 200, the system 330, or the system 500. The system 803 may be implemented in a public networking environment or a private networking environment. In an example, the computing environment 800 may include a processing resource 804 communicatively coupled to the non-transitory computer-readable medium 802 through a communication link 806.

In an example, the processing resource 804 may be implemented in a device, such as the system 803. The non-transitory computer-readable medium 802 may be, for example, an internal memory device of the system 803 or an external memory device. In an implementation, the communication link 806 may be a direct communication link, such as any memory read/write interface. In another implementation, the communication link 806 may be an indirect communication link, such as a network interface. In such a case, the processing resource 804 may access the non-transitory computer-readable medium 802 through a network 808. The network 808 may be a single network or a combination of multiple networks and may use a variety of different communication protocols. The processing resource 804 and the non-transitory computer-readable medium 802 may also be communicatively coupled to the system 803 over the network 808.

In an example implementation, the non-transitory computer-readable medium 802 includes a set of computer-readable instructions to monitor performance of controllers. The set of computer-readable instructions can be accessed by the processing resource 804 through the communication link 806 and subsequently executed to perform acts to monitor performance of the controllers.

Referring to FIG. 8a, in an example, the non-transitory computer-readable medium 802 includes instructions 812 to obtain, from a performance controller, a first set of KPIs corresponding to the performance controller. The performance controller may be configured to control a compressor. The first set of the KPIs may be indicative of performance of the performance controller. The performance controller may correspond to the controller 102 or the performance controller 202.

The non-transitory computer-readable medium 802 includes instructions 814 to configure a first user-defined analysis model based on a first set of user inputs. The non-transitory computer-readable medium 802 includes instructions 816 to select, based on the first user-defined analysis model, a first plurality of KPIs from the first set of KPIs.

The non-transitory computer-readable medium 802 includes instructions 818 to determine a first CQI based on the first plurality of KPIs selected from the first set of KPIs using the first user-defined analysis model. The first CQI may define performance of the performance controller in terms of utilization of the performance controller, availability of the performance controller, and reliability of the performance controller.

The non-transitory computer-readable medium 802 includes instructions 820 to compare the first CQI with a threshold value upon the determination of the first CQI. The non-transitory computer-readable medium 802 includes instructions 822 to ascertain if the first CQI is lesser than the threshold value based on the comparison. The non-transitory computer-readable medium 802 includes instructions 824 to trigger a first notification indicating that the first CQI is less than the threshold value and generate a first action indicating corrective measures to be taken to improve performance of the performance controller based on the ascertaining that the first CQI is lesser than the threshold value.

The non-transitory computer-readable medium 802 includes instructions 826 to refrain from triggering the first notification and from generating the first action indicating the corrective measures based on the ascertaining that the first CQI is greater than the threshold value.

In an example, the first set of user inputs may include a time period for the determination of the first CQI. The non-transitory computer-readable medium 802 includes instructions to define, based on the first user-defined analysis model, a time period for the determination of the first CQI. Further, the non-transitory computer-readable medium 802 includes instructions to determine, using the first user-defined analysis model, the first CQI for the defined period.

The non-transitory computer-readable medium 802 includes instructions to obtain, from an anti-surge controller, a second set of KPIs corresponding to the anti-surge controller that corresponds to the compressor. The second set of the KPIs may be indicative of performance of the anti-surge controller. The anti-surge controller may correspond to the controller 102 or the anti-surge controller 204. The non-transitory computer-readable medium 802 includes instructions to configure a second user-defined analysis model based on a second set of user inputs. The non-transitory computer-readable medium 802 includes instructions to select, based on the second user-defined analysis model, a second plurality of KPIs from the second set of KPIs. The non-transitory computer-readable medium 802 includes instructions to determine a second CQI based on the second plurality of KPIs selected from the second set of KPIs using the second user-defined analysis model. The second CQI may define performance of the anti-surge controller in terms of utilization of the anti-surge controller, availability of the anti-surge controller, and reliability of the anti-surge controller. The non-transitory computer-readable medium 802 includes instructions to compare the second CQI with a threshold value in response to the determination of the second CQI. The non-transitory computer-readable medium 802 includes instructions to ascertain if the second CQI is lesser than the threshold value based on the comparison. The non-transitory computer-readable medium 802 includes instructions to trigger a second notification indicating that the second CQI is less than the threshold value and generate a second action indicating corrective measures to be taken to improve performance of the anti-surge controller based on the ascertaining that the second CQI is lesser than the threshold value. The non-transitory computer-readable medium 802 includes instructions to refrain from triggering the second notification and generating the second action indicating the corrective measures based on the ascertaining that the second CQI is greater than the threshold value.

In an example, the second set of user inputs may include a time period for the determination of the second CQI. The non-transitory computer-readable medium 802 includes instructions to define, based on the second user-defined analysis model, the time period for the determination of the second CQI. The non-transitory computer-readable medium 802 includes instructions to determine, using the second user-defined analysis model, the second CQI for the time period.

The present subject matter facilitates monitoring performance of controllers. The present subject matter provides an overall assessment of a controller's performance is provided in terms of availability, reliability, and utilization that is easy-to-understand. The provision of overall assessment enables monitoring performance of multiple controllers easily and simultaneously. Therefore, with the present subject matter, the controllers that require corrective measures can be attended to without any time delay irrespective of scale of the controllers. By eliminating the need to analyze multiple KPIs for each controller, the present subject matter significantly reduces time and effort required for performance monitoring of controllers. The present subject matter enables determination of CQI on-the-fly for user-defined time durations. This enables providing insights into controller performance over a period of time. The system can automatically notify users if the CQI reaches ‘bad’ status or ‘poor’ status. Thus, the present subject matter eliminates constant manual monitoring required by the users. Further, with the present subject matter, the singular metric can be determined based on default setting or can be determined based on settings provided by the user. Accordingly, the present subject matter enables flexibility in the determination of the overall assessment of the performance of the controllers. In the present subject matter, the data from the performance controller and the anti-surge controller are obtained in OPC architecture in the form of CSV using SFTP. Accordingly, the present subject matter can handle high frequency of data, in terms of milliseconds.

Although examples and implementations of present subject matter have been described in language specific to structural features and/or methods, it is to be understood that the present subject matter is not necessarily limited to the specific features or methods described. Rather, the specific features and methods are disclosed and explained in the context of a few example implementations of the present subject matter.

What is claimed is:

1. A system for monitoring performance of controllers, the system comprising a processing unit to:
obtain a set of key performance indicators corresponding to a controller, the controller configured to control a compressor, the set of the key performance indicators being indicative of performance of the controller;
configure a user-defined analysis model based on a set of user inputs;
determine a control quality index (CQI) based on a plurality of key performance indicators from the set of key performance indicators using the user-defined analysis model, the CQI defining performance of the controller in terms of utilization of the controller, availability of the controller, and reliability of the controller;
compare the CQI with a threshold value using the user-defined analysis model in response to the determination of the CQI;
ascertain if the CQI is lesser than the threshold value based on the comparison;
trigger a notification indicating that the CQI is less than the threshold value based on the ascertaining that the CQI is lesser than the threshold value; and
generate an action indicating corrective measures to be taken to improve performance of the controller based on the ascertaining that the CQI is lesser than the threshold value.

2. The system as claimed in claim 1, wherein the processing unit is to select, based on the user-defined analysis model, the plurality of key performance indicators from the set of key performance indicators in response to the configuration of the user-defined analysis model.

3. The system as claimed in claim 1, wherein the key performance indicators comprise an effective service factor of the controller, a standard deviation of the controller, and an output deviation of the controller, and wherein using the user-defined analysis model, the processing unit is to:
compare the effective service factor of the controller with an effective service factor threshold, the standard deviation of the controller with a standard deviation threshold, and the output deviation of the controller with an output deviation threshold; and
determine the CQI based on the comparison the effective service factor of the controller and the effective service factor threshold, the standard deviation of the controller and the standard deviation threshold, and the output deviation of the controller and the output deviation threshold.

4. The system as claimed in claim 3, wherein using the user-defined analysis model, the processing unit is to determine the CQI as a first value if the effective service factor of the controller is at least one of: lesser than and equal to the effective service factor threshold, if the standard deviation of the controller is at least one of: equal to and greater than the standard deviation threshold, and the output deviation of the controller is at least one of: equal to and greater than the output deviation threshold.

5. The system as claimed in claim 3, wherein using the user-defined analysis model, the processing unit is to determine the CQI as a second value if the effective service factor of the controller is greater than the effective service factor threshold, if the standard deviation of the controller is at least one of: equal to and greater than the standard deviation threshold, and the output deviation of the controller is at least one of: equal to and greater than the output deviation threshold.

6. The system as claimed in claim 3, wherein using the user-defined analysis model, the processing unit is to determine the CQI as a third value if the effective service factor of the controller is greater than the effective service factor threshold, if the standard deviation of the controller is less than the standard deviation threshold, and the output deviation of the controller is less than the output deviation threshold, wherein the third value being the threshold value.

7. The system as claimed in claim 1, wherein the controller is one of: a performance controller and an anti-surge controller.

8. The system as claimed in claim 1, wherein the set of user inputs comprises a time period for the determination of the CQI, wherein the processing unit is to:
define, based on the user-defined analysis model, a time period for the determination of the CQI; and
determine, using the user-defined analysis model, the CQI for the defined time period.

9. The system as claimed in claim 1, wherein the processing unit is to display, on a device, at least one of: the CQI, the notification, and the generated action.

10. A method for monitoring performance of controllers, the method comprising:
obtaining, from a first controller, a first set of key performance indicators corresponding to the first controller, the first set of the key performance indicators being indicative of performance of the first controller;
obtaining, from a second controller, a second set of key performance indicators corresponding to the second controller, the first controller and the second controller being configured to control a compressor, the second set of the key performance indicators being indicative of performance of the second controller;
configuring a first user-defined analysis model based on a first set of user inputs and a second user-defined analysis model based on a second set of user inputs;
determining a first control quality index (CQI) based on a first plurality of key performance indicators from the first set of key performance indicators using the first user-defined analysis model, the first CQI defining performance of the first controller in terms of utilization of the controller, availability of the controller, and reliability of the controller;
determining a second CQI based on a second plurality of key performance indicators from the second set of key performance indicators using the second user-defined analysis model, the second CQI defining performance of the second controller in terms of utilization of the controller, availability of the controller, and reliability of the controller;
comparing the first CQI with a first threshold value in response to the determination of the first CQI using the first user-defined analysis model and the second CQI with a second threshold value using the second user-defined analysis model in response to the determination of the second CQI;
triggering a first notification indicating that the first CQI is lesser than the first threshold value and generating a first action indicating corrective measures to be taken to improve performance of the first controller if it is ascertained that the first CQI is lesser than the first threshold value; and
triggering a second notification indicating that the second CQI is lesser than the second threshold value and generating a second action indicating corrective measures to be taken to improve performance of the second controller if it is ascertained that the second CQI is lesser than the second threshold value.

11. The method as claimed in claim 10, comprising:
selecting, based on the first user-defined analysis model, the first plurality of key performance indicators from the first set of key performance indicators; and
selecting, based on the second user-defined analysis model, the second plurality of key performance indicators from the second set of key performance indicators.

12. The method as claimed in claim 10, wherein the first controller is one of: a performance controller and an anti-surge controller and the second controller is other of: the performance controller and the anti-surge controller.

13. The method as claimed in claim 10, wherein the first controller is a performance controller, and wherein the first plurality of key performance indicators comprises an effective service factor of the first controller, a standard deviation of the first controller, and an output deviation of the first controller, and wherein the method comprises:
comparing, using the first user-defined analysis model, the effective service factor of the first controller with an effective service factor threshold, the standard deviation of the first controller with a standard deviation threshold, and the output deviation of the first controller with an output deviation threshold; and
determining, using the first user-defined analysis model, the first CQI based on the comparison the effective service factor of the first controller and the effective service factor threshold, the standard deviation of the first controller and the standard deviation threshold, and the output deviation of the first controller and the output deviation threshold.

14. The method as claimed in claim 10, wherein the second controller is an anti-surge controller, and wherein the second plurality of key performance indicators comprise an effective service factor of the second controller, an effectiveness of the second controller, and an output deviation of the second controller, and wherein the method comprises:
comparing, using the second user-defined analysis model, the effective service factor of the second controller with an effective service factor threshold, the effectiveness of the second controller with an effectiveness threshold, and the output deviation of the second controller with an output deviation threshold; and
determining, using the second user-defined analysis model, the second CQI based on the comparison the effective service factor of the second controller and the effective service factor threshold, the effectiveness of the second controller and the effectiveness threshold, and the output deviation of the second controller and the output deviation threshold.

15. The method as claimed in claim 14, the method comprising:
determining, by using the second user-defined analysis model, the second CQI as a first value if the effective service factor of the second controller is at least one of: lesser than and equal to the effective service factor threshold, if the effectiveness of the second controller is at least one of: equal to and greater than the effectiveness threshold, and the output deviation of the second controller is at least one of: equal to and greater than the output deviation threshold;
determining, by using the second user-defined analysis model, the second CQI as a second value if the effective service factor of the second controller is greater than the effective service factor threshold, if the effectiveness of the second controller is at least one of: equal to and greater than the effectiveness threshold, and the output deviation of the second controller is at least one of: equal to and greater than the output deviation threshold; and
determining, by using the second user-defined analysis model, the second CQI as a third value if the effective service factor of the second controller is greater than the effective service factor threshold, if the effectiveness of the second controller is less than the effectiveness threshold, and the output deviation of the second controller is less than the output deviation threshold, wherein the third value being the threshold value.

16. The method as claimed in claim 10, wherein obtaining the first set of key performance indicators from the first controller comprises:
establishing connection, by using a transfer service, with the first controller;
subscribing, by the transfer service, to tags of data corresponding to the first set of key performance indicators using Open Platform Communication (OPC) protocol;
pulling, by the transfer service, the first set of key performance indicators in response to determining a change in data corresponding to the first set of key performance indicators; and
transmitting, by the transfer service, the first set of key performance indicators in Comma Separated Value (CSV) format using Secure File Transfer Protocol (SFTP).

17. A non-transitory computer-readable medium comprising instructions for monitoring performance of controllers, the instructions being executable by a processing resource to:
obtain, from a performance controller, a first set of key performance indicators corresponding to the performance controller, the performance controller being configured to control a compressor, the first set of the key performance indicators being indicative of performance of the performance controller;
configure a first user-defined analysis model based on a first set of user inputs;
select, based on the first user-defined analysis model, a first plurality of key performance indicators from the first set of key performance indicators;
determine a first control quality index (CQI) based on the first plurality of key performance indicators selected from the first set of key performance indicators using the first user-defined analysis model, the first CQI defining performance of the performance controller in terms of utilization of the performance controller, availability of the performance controller, and reliability of the performance controller;
compare the first CQI with a threshold value using the first user-defined analysis model upon the determination of the first CQI;
ascertain if the first CQI is lesser than the threshold value based on the comparison;
trigger a first notification indicating that the first CQI is less than the threshold value and generate a first action indicating corrective measures to be taken to improve performance of the performance controller based on the ascertaining that the first CQI is lesser than the threshold value; and
refrain from triggering the first notification and from generating the first action indicating the corrective measures based on the ascertaining that the first CQI is greater than the threshold value.

18. The non-transitory computer-readable medium of claim 17, wherein the first set of user inputs comprises a time period for the determination of the first CQI, the instructions being executable by the processing resource to:
define, based on the first user-defined analysis model, a time period for the determination of the first CQI; and
determine, using the first user-defined analysis model, the first CQI for the time period.

19. The non-transitory computer-readable medium of claim 17, the instructions being executable by the processing resource to:
obtain, from an anti-surge controller, a second set of key performance indicators corresponding to the anti-surge controller that corresponds to a compressor, the second set of the key performance indicators being indicative of performance of the anti-surge controller;
configure a second user-defined analysis model based on a second set of user inputs;
select, based on the second user-defined analysis model, a second plurality of key performance indicators from the second set of key performance indicators;
determine a second CQI based on the second plurality of key performance indicators selected from the second set of key performance indicators using the second user-defined analysis model, the second CQI defining performance of the anti-surge controller in terms of utilization of the anti-surge controller, availability of the anti-surge controller, and reliability of the anti-surge controller;
compare the second CQI with a threshold value using the second user-defined analysis model in response to the determination of the second CQI;
ascertain if the second CQI is lesser than the threshold value based on the comparison;
trigger a second notification indicating that the second CQI is less than the threshold value and generate a second action indicating corrective measures to be taken to improve performance of the anti-surge controller based on the ascertaining that the second CQI is lesser than the threshold value; and
refrain from triggering the second notification and generating the second action indicating the corrective measures based on the ascertaining that the second CQI is greater than the threshold value.

20. The non-transitory computer-readable medium of claim 19, wherein the second set of user inputs include a time period for the determination of the second CQI, the instructions being executable by the processing resource to:
define, based on the second user-defined analysis model, the time period for the determination of the second CQI; and
determine, using the second user-defined analysis model, the second CQI for the time period.
